(19) United States
(12) Patent Application Publication
(10) Pub. No.: US 2025/0188287 A1
(43) Pub. Date: Jun. 12, 2025

(54) MULTI-LAYERED COATED METAL SUBSTRATES

(71) Applicant: PRC-DESOTO INTERNATIONAL, INC., Sylmar, CA (US)

(72) Inventors: Victor Franklin Georgic, Pittsburgh, PA (US); David Neil Walters, Slippery Rock, PA (US); Elizabeth Anne Furar, Pittsburgh, PA (US); Brian Kirk Rearick, Allison Park, PA (US); James Dean Begley, Evans City, PA (US)

(73) Assignee: PRC-DESOTO INTERNATIONAL, INC., Sylmar, CA (US)

(21) Appl. No.: 18/842,079

(22) PCT Filed: Dec. 30, 2022
(86) PCT No.: PCT/US2022/082657

§ 371 Date: Aug. 28, 2024

Related U.S. Application Data
(60) Provisional application No. 63/268,763, filed on Mar. 2, 2022.

(51) Int. Cl. C09D 5/10; C09D 163/00

(52) U.S. Cl. CPC C09D 5/106; C09D 5/103; C09D 163/00

(57) ABSTRACT

The present disclosure is directed towards a coated metal substrate comprising a first coating layer comprising zinc particles and a binder comprising a first organic film-forming binder or an inorganic binder, wherein the first coating layer comprises zinc particles in an amount of at least 75% by weight, based on the total weight of the first coating layer; a second coating layer on the first coating layer, the second coating layer comprising aluminum metal particles, an alkaline earth metal compound, and a second organic binder; and optionally, a third coating layer. Also disclosed are systems and methods for coating metal substrates.

### NOTICE OF GOVERNMENT SUPPORT

This disclosure was made with Government support under Government Contract No. N00014-17-C-1012 awarded by the Office of Naval Research; Collaboration Agreement No. 201636-140830, with National Center for Manufacturing Sciences, Inc. (NCMS), performed under Cooperative Agreement Award No. HQ0034-15-2-0007 awarded to NCMS by Tank Automotive Research Development and Engineering Center (TARDEC); and Government Contract No. W9132T-17-C-0021, awarded by Construction Engineering Research Laboratory. The United States Government has certain rights in this disclosure.

### FIELD

The present disclosure is directed to coated metal substrates, systems for coating metal substrates, and methods of coating metal substrates.

### BACKGROUND INFORMATION

Coatings are applied to appliances, automobiles, aircraft, and the like for a number of reasons, typically for decorative and/or protective purposes. For example, to improve the corrosion resistance of a metal substrate, corrosion inhibitors may be used in the coatings applied to the substrate. Improved corrosion resistance in coatings is desired, particularly without the use of carcinogenic materials.

### SUMMARY

The present disclosure is directed to a coated metal substrate comprising a first coating layer comprising zinc particles and a binder comprising a first organic film-forming binder or an inorganic binder, wherein the first coating layer comprises zinc particles in an amount of at least 75% by weight, based on the total weight of the first coating layer; a second coating layer on the first coating layer, the second coating layer comprising aluminum metal particles, an alkaline earth metal compound, and a second organic binder; and optionally, a third coating layer.

The present disclosure is also directed to a system for coating a metal substrate, the system comprising a first coating composition comprising zinc particles and a binder comprising a first organic film-forming binder or an inorganic binder, wherein the first coating composition comprises zinc particles in an amount of at least 75% by weight, based on the total solids weight of the first coating composition; a second coating composition comprising aluminum metal particles, an alkaline earth metal compound, and a second organic binder; and optionally, a third coating composition.

The present disclosure is further directed to a method for coating a metal substrate, the method comprising applying a first coating composition onto a surface of the metal substrate to form a first coating layer, the first coating composition comprising zinc particles and a binder comprising a first organic film-forming binder or an inorganic binder, wherein the coating layer comprises zinc particles in an amount of at least 75% by weight, based on the total solids weight of the first coating composition; applying a second coating composition onto the first coating layer to form a second coating layer on the first coating layer, the second coating composition comprising aluminum particles, an alkaline earth metal compound, and a second organic film-forming binder; and optionally, applying a third coating composition onto the second coating layer to form a third coating layer.

### DETAILED DESCRIPTION

As stated above, the present disclosure is directed to a coated metal substrate comprising a first coating layer comprising zinc particles and a binder comprising a first organic film-forming binder or an inorganic binder, wherein the first coating layer comprises zinc particles in an amount of at least 75% by weight, based on the total weight of the first coating layer; a second coating layer on the first coating layer, the second coating layer comprising aluminum metal particles, an alkaline earth metal compound, and a second organic binder; and optionally, a third coating layer.

The present disclosure is also directed to a system for coating a metal substrate, the system comprising a first coating composition comprising zinc particles and a binder comprising a first organic film-forming binder or an inorganic binder, wherein the first coating composition comprises zinc particles in an amount of at least 75% by weight, based on the total weight of the first coating composition; a second coating composition comprising aluminum metal particles, an alkaline earth metal compound, and a second organic binder; and optionally, a third coating layer.

### First Coating Layer/First Coating Composition

According to the present disclosure, the coated metal substrate comprises a first coating layer comprising zinc particles and a binder comprising a first organic film-forming binder or an inorganic binder, wherein the first coating layer comprises zinc particles in an amount of at least 75% by weight, based on the total weight of the first coating layer.

According to the present disclosure, the system for coating a metal substrate comprises a first coating composition comprising zinc particles and a binder comprising a first organic film-forming binder or an inorganic binder, wherein the coating layer comprises zinc particles in an amount of at least 75% by weight, based on the total solids weight of the first coating composition. As used herein, the term “system” is understood in the context of this application to be synonymous with the term “kit” and refers to a set comprising different coating compositions that can be used together in order to coat a metal substrate.

The zinc particles may comprise zinc metal, zinc alloy, or any combination thereof.

As used herein, the terms “zinc metal” or “zinc metal particles” refers to metal particles comprising at least 92% metallic zinc with the rest of the particle including impurities in the form of other metals or metal oxides, such as, for example, metal particles marketed as zinc powder, zinc dust, or zinc flake, and includes metal particles having up to 100% metallic zinc.

As used herein, the term “metal” with respect to particles refers to elemental (i.e., zerovalent) metal and metal alloys. As used herein, the term “particles” refers to material in the form of particulates, such as powder or dust, as well as flakes, and may be in the form of any shape, such as, for example, spherical, ellipsoidal, cubical, rod-shaped, disk-shaped, prism-shaped, and the like. Accordingly, the metal particles may comprise, consist essentially of, or consist of powders, dusts, flakes, or any combination thereof. The metal particles may comprise, consist essentially of, or consist of spherical, ellipsoidal, cubical, rod-shaped, disk-shaped, prism-shaped particles, or any combination thereof.

The zinc particles may have an average particle size of at least 1 micron. such as at least 2 microns, at least 4 microns, such as at least 5 microns, such as at least 6 microns, such as at least 10 microns. The zinc particles may have an average particle size of no more than 150 microns, such as no more than 28 microns, such as no more than 20 microns, such as no more than 12 microns, such as no more than 10 microns, such as no more than 8 microns. The zinc particles may have an average particle size of 1 to 150 microns, such as 1 to 28 microns, such as 1 to 20 microns, such as 1 to 12 microns, such as 1 to 10 microns, such as 1 to 8 microns, such as 2 to 28 microns, such as 2 to 20 microns, such as 2 to 12 microns, such as 2 to 10 microns, such as 2 to 8 microns, such as 4 to 28 microns, such as 4 to 20 microns, such as 4 to 12 microns, such as 4 to 10 microns, such as 4 to 8 microns, such as 5 to 28 microns, such as 5 to 20 microns, such as 5 to 12 microns, such as 5 to 10 microns, such as 5 to 8 microns, such as 6 to 28 microns, such as 6 to 20 microns, such as 6 to 12 microns, such as 6 to 10 microns, such as 6 to 8 microns, such as 1 to 28 microns, such as 10 to 20 microns, such as 10 to 12 microns. The particle size selected may be dependent upon the thickness of the desired coating. For example, thin coatings may require smaller particle sizes, while thicker coatings could tolerate larger particles. The average particle size as reported herein is the average particle size as provided by the metal particulate manufacturer and may be measured by various methods known in the art, such as, for example, laser diffraction.

The first coating layer and first coating composition may comprise at least 75% by weight zinc particles, such as at least 80% by weight, such as at least 85% by weight, based on the total weight of the first coating layer or total solids weight of the first coating composition. The first coating layer and first coating composition may comprise no more than 95% by weight zinc particles, such as no more than 90% by weight zinc particles, such as no more than 85% by weight zinc particles, based on the total weight of the first coating layer or total solids weight of the first coating composition. The first coating layer and first coating composition may comprise 75% to 95% by weight zinc particles, such as 75% to 90% by weight zinc particles, such as 75% to 85% by weight zinc particles, such as 80% to 95% by weight zinc particles, such as 80% to 90% by weight zinc particles, such as 80% to 85% by weight zinc particles, such as 85% to 95% by weight zinc particles, such as 85% by weight to 90% by weight zinc particles, based on the total weight of the first coating layer or total solids weight of the first coating composition.

According to the present disclosure, the first coating and first coating composition further comprise a binder comprising, consisting essentially of, or consisting of a first organic film-forming binder.

The organic film-forming binder comprises an organic film-forming resin. As used herein, the term “film-forming resin” refers to resins that can form a self-supporting continuous film on at least a horizontal surface of a substrate upon removal of any diluents or carriers present in the composition or upon curing at ambient or elevated temperature. As used herein, a binder will be considered to be an “organic film-forming binder” if the binder comprises organic-based materials present in an amount of greater than 50% by weight, based on the total weight of the total binder composition, such as at least 51% by weight, such as at least 75% by weight, such as at least 85% by weight, such as at least 95% by weight, such as at least 99% by weight, and may be 100% by weight, based on the total weight of the binder. As used herein, the term “total weight of the binder” refers to the total weight of all resinous materials and curing agents present in the composition that are intended to react during cure to crosslink the binder. The organic film-forming binder may comprise 51% to 100% by weight of organic-based materials, such as 75% to 100% by weight, such as 85% to 100% by weight, such as 95% to 100% by weight, such as 99% to 100% by weight, such as 100% by weight, based on the total weight of the binder composition. The remainder of the binder may comprise inorganic materials present in an amount of less than 50% by weight, based on the total weight of the binder composition. The term “organic-based material” refers to carbon-based materials such as the organic film-forming resins and curing agents described herein. Organic-inorganic hybrid binders may also be considered to be organic film-forming binders if the organic content of the hybrid binder is greater than 50% by weight, based on the total weight of the organic-inorganic hybrid binder. The organic film-forming binder will comprise less than 50% by weight of inorganic elements, such as silicon and titanium, based on the total weight of the organic-based material. For clarity, the term organic-based material explicitly excludes inorganic binders, as that term is defined herein.

The organic film-forming binder may comprise a curable organic film-forming binder such as the coating comprises a thermoset coating and the coating composition comprises a thermosetting or curable coating composition. As used herein, the terms “thermosetting” and “curable” can be used interchangeably and refer to resins that “set” irreversibly upon curing or crosslinking, wherein the polymer chains of the polymeric components are joined together by covalent bonds. This property is usually associated with a crosslinking reaction of the composition constituents often induced, for example, by heat or radiation. See Hawley, Gessner G., The Condensed Chemical Dictionary, Ninth Edition., page 856; Surface Coatings, vol. 2, Oil and Colour Chemists' Association, Australia, TAFE Educational Books (1974). Alternatively, curing or crosslinking reactions also may be carried out under ambient conditions for a period of 30 days or less, such as 21 days or less, such as 14 days or less, such as 7 days or less, or a shorter time period. By ambient conditions is meant that the coating undergoes a thermosetting reaction without the aid of heat or other energy, for example, without baking in an oven, use of forced air, or the like. Usually, ambient conditions include temperature ranging from 60 to 90° F. (15.6 to 32.2° C.), such as a typical room temperature, 72° F. (22.2° C.), standard atmospheric pressure (101.325 kPa, 1.01325 bar or 1 atm) and about 30-65%, such as about 50% relative humidity. Once cured or crosslinked, a thermosetting resin will not melt upon the application of heat and is insoluble in solvents. The curable film-forming compositions of the present disclosure may be solvent-borne, 100% solids, or powder coating composition. The curable compositions comprise a curable organic film-forming binder component. The organic film-forming binder component may comprise (a) a film-forming resin component comprising reactive functional groups; and (b) a curing agent component comprising functional groups that are reactive with the functional groups in the resin component (a), although the film-forming resin component may also crosslink with itself rather than an additional curing agent (i.e., self-crosslinking binder).

Film-forming resins that may be used in the coatings and coating compositions of the present disclosure include, without limitation, those used in automotive OEM coating compositions, automotive refinish coating compositions, industrial coating compositions, architectural coating compositions, coil coating compositions, marine coating compositions, and aerospace coating compositions, among others.

The organic film-forming resin may comprise one or more of addition polymers, polyolefins, polysulfides, polyureas, polyesters, polyurethanes, polyamides, polyethers, polythioethers, polythioesters, polythiols, polyenes, polyols, polyacetoacetate, polysilanes, polysiloxanes, fluoropolymers, polycarbonates, and epoxy resins. Generally, these compounds, which need not be polymeric, can be made by any method known to those skilled in the art. The functional groups on the film-forming binder may be comprise at least one of carboxylic acid groups, amine groups, epoxide groups, hydroxyl groups, thiol groups, carbamate groups, amide groups, urea groups, (meth)aciylate groups, styrenic groups, vinyl groups, allyl groups, aldehyde groups, acetoacetate groups, hydrazide groups, cyclic carbonates, acrylates, alkoxy silane groups, maleic and mercaptan groups. The functional groups on the film-forming resin are selected so as to be reactive with those on a curing agent, described herein, or to be self-crosslinking, and the film-forming resin may comprise two or more functional groups per molecule.

Suitable addition polymers include acrylic polymers and other polymers formed from reaction of unsaturated monomers, such as vinyls. Suitable acrylic polymers include copolymers of one or more alkyl esters of acrylic acid or methacrylic acid, optionally together with one or more other polymerizable ethylenically unsaturated monomers. Useful alkyl esters of acrylic acid or methacrylic acid include aliphatic alkyl esters containing from 1 to 30, and often 4 to 18 carbon atoms in the alkyl group. Non-limiting examples include methyl methacrylate, ethyl methacrylate, butyl methacrylate, ethyl acrylate, butyl acrylate, and 2-ethyl hexyl acrylate. Suitable other copolymerizable ethylenically unsaturated monomers include vinyl aromatic compounds such as styrene and vinyl toluene; nitriles such as acrylonitrile and methacrylonitrile; vinyl and vinylidene halides such as vinyl chloride and vinylidene fluoride and vinyl esters such as vinyl acetate.

The acrylic copolymer can include hydroxyl functional groups, which are often incorporated into the polymer by including one or more hydroxyl functional monomers in the reactants used to produce the copolymer. Useful hydroxyl functional monomers include hydroxyalkyl acrylates and methacrylates, typically having 2 to 4 carbon atoms in the hydroxyalkyl group, such as hydroxyethyl acrylate, hydroxypropyl acrylate, 4-hydroxybutyl acrylate, hydroxy functional adducts of caprolactone and hydroxyalkyl acrylates, and corresponding methacrylates, as well as the beta-hydroxy ester functional monomers described below. The acrylic polymer can also be prepared with N-(alkoxymethyl)acrylamides and N-(alkoxymethyl)methacrylamides.

Beta-hydroxy ester functional monomers can be prepared from ethylenically unsaturated, epoxy functional monomers and carboxylic acids having from about 13 to about 20 carbon atoms, or from ethylenically unsaturated acid functional monomers and epoxy compounds containing at least 5 carbon atoms which are not polymerizable with the ethylenically unsaturated acid functional monomer.

Useful ethylenically unsaturated, epoxy functional monomers used to prepare the beta-hydroxy ester functional monomers include glycidyl acrylate, glycidyl methacrylate, allyl glycidyl ether, methallyl glycidyl ether, 1:1 (molar) adducts of ethylenically unsaturated monoisocyanates with hydroxy functional monoepoxides such as glycidol, and glycidyl esters of polymerizable polycarboxylic acids such as maleic acid. (Note: these epoxy functional monomers may also be used to prepare epoxy functional acrylic polymers.) Examples of carboxylic acids include saturated monocarboxylic acids such as isostearic acid and aromatic unsaturated carboxylic acids.

Useful ethylenically unsaturated acid functional monomers used to prepare the beta-hydroxy ester functional monomers include monocarboxylic acids such as acrylic acid, methacrylic acid, crotonic acid; dicarboxylic acids such as itaconic acid, maleic acid and fumaric acid; and monoesters of dicarboxylic acids such as monobutyl maleate and monobutyl itaconate. The ethylenically unsaturated acid functional monomer and epoxy compound are typically reacted in a 1:1 equivalent ratio. The epoxy compound does not contain ethylenic unsaturation that would participate in free radical-initiated polymerization with the unsaturated acid functional monomer. Useful epoxy compounds include 1,2-pentene oxide, styrene oxide and glycidyl esters or ethers, often containing from 4 to 30 carbon atoms, such as butyl glycidyl ether, octyl glycidyl ether, phenyl glycidyl ether and para-(tertiary butyl)phenyl glycidyl ether. Particular glycidyl esters include those of the structure:

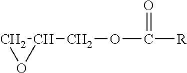

where R is a hydrocarbon radical containing from about 4 to about 26 carbon atoms. Typically, R is a branched hydrocarbon group having from about 4 to about 10 carbon atoms, such as neopentanoate, neoheptanoate or neodecanoate. Suitable glycidyl esters of carboxylic acids include VERSATIC ACID 91 1 and CARDURA E, each of which is commercially available from Shell Chemical Co.

Carbamate functional groups can be included in the acrylic polymer by copolymerizing the acrylic monomers with a carbamate functional vinyl monomer, such as a carbamate functional alkyl ester of methacrylic acid, or by reacting a hydroxyl functional acrylic polymer with a carbamate functional material, such as can be derived from an alcohol or glycol ether, via a transcarbamoylation reaction. In this reaction, a low molecular weight carbamate functional material derived from an alcohol or glycol ether is reacted with the hydroxyl groups of the acrylic polyol, yielding a carbamate functional acrylic polymer and the original alcohol or glycol ether. The low molecular weight carbamate functional material derived from an alcohol or glycol ether may be prepared by reacting the alcohol or glycol ether with urea in the presence of a catalyst. Suitable alcohols include lower molecular weight aliphatic, cycloaliphatic, and aromatic alcohols such as methanol, ethanol, propanol, butanol, cyclohexanol, 2-ethylhexanol, and 3-methylbutanol. Suitable glycol ethers include ethylene glycol methyl ether and propylene glycol methyl ether. Propylene glycol methyl ether and methanol are most often used. Other carbamate functional monomers as known to those skilled in the art may also be used.

Amide functionality may be introduced to the acrylic polymer by using suitably functional monomers in the preparation of the polymer, or by converting other functional groups to amido-groups using techniques known to those skilled in the art. Likewise, other functional groups may be incorporated as desired using suitably functional monomers if available or conversion reactions as necessary.

Acrylic polymers can be prepared via aqueous emulsion polymerization techniques and used directly in the preparation of aqueous coating compositions or can be prepared via organic solution polymerization techniques for solvent-borne compositions. When prepared via organic solution polymerization with groups capable of salt formation such as acid or amine groups, upon neutralization of these groups with a base or acid the polymers can be dispersed into aqueous medium. Generally, any method of producing such polymers that is known to those skilled in the art utilizing art recognized amounts of monomers can be used.

Besides acrylic polymers, the resin component (a) in the film-forming binder component of the curable film-forming composition may be an alkyd resin or a polyester. Such polymers may be prepared in a known manner by condensation of polyhydric alcohols and polycarboxylic acids. Suitable polyhydric alcohols include, but are not limited to, ethylene glycol, propylene glycol, butylene glycol, 1,6-hexylene glycol, neopentyl glycol, diethylene glycol, glycerol, trimethylol propane, and pentaerythritol. Suitable polycarboxylic acids include, but are not limited to, succinic acid, adipic acid, azelaic acid, sebacic acid, maleic acid, fumaric acid, phthalic acid, tetrahydrophthalic acid, hexahydrophthalic acid, and trimellitic acid. Besides the polycarboxylic acids mentioned above, functional equivalents of the acids such as anhydrides where they exist or lower alkyl esters of the acids such as the methyl esters may be used. Where it is desired to produce air-drying alkyd resins, suitable drying oil fatty acids may be used and include, for example, those derived from linseed oil, soya bean oil, tall oil, dehydrated castor oil, or tung oil. Likewise, polyamides may be prepared utilizing polyacids and polyamines. Suitable polyacids include those listed above and polyamines may be selected from at least one of ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotolulene diamine, 2,4′- and/or 4,4′-diamino-dicyclohexyl methane and 3,3′-dialkyl-4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane.

Carbamate functional groups may be incorporated into the polyester or polyamide by first forming a hydroxyalkyl carbamate which can be reacted with the polyacids and polyols/polyamines used in forming the polyester or polyamide. The hydroxyalkyl carbamate is condensed with acid functionality on the polymer, yielding terminal carbamate functionality. Carbamate functional groups may also be incorporated into the polyester by reacting terminal hydroxyl groups on the polyester with a low molecular weight carbamate functional material via a transcarbamoylation process similar to the one described above in connection with the incorporation of carbamate groups into the acrylic polymers, or by reacting isocyanic acid with a hydroxyl functional polyester.

Other functional groups such as amine, amide, thiol, urea, or others listed above may be incorporated into the polyamide, polyester or alkyd resin as desired using suitably functional reactants if available, or conversion reactions as necessary to yield the desired functional groups. Such techniques are known to those skilled in the art.

Polyurethanes can also be used as the resin component (a) in the film-forming binder component of the curable film-forming composition. Among the polyurethanes which can be used are polymeric polyols which generally are prepared by reacting the polyester polyols or acrylic polyols such as those mentioned above with a polyisocyanate such that the OH/NCO equivalent ratio is greater than 1:1 so that free hydroxyl groups are present in the product. The organic polyisocyanate which is used to prepare the polyurethane polyol can be an aliphatic or an aromatic polyisocyanate or a mixture of the two. Diisocyanates are typically used, although higher polyisocyanates can be used in place of or in combination with diisocyanates. Examples of suitable aromatic diisocyanates are 4,4′-diphenylmethane diisocyanate and toluene diisocyanate. Examples of suitable aliphatic diisocyanates are straight chain aliphatic diisocyanates such as 1,6-hexamethylene diisocyanate. Also, cycloaliphatic diisocyanates can be employed. Examples include isophorone diisocyanate and 4,4′-methylene-bis-(cyclohexyl isocyanate). Examples of suitable higher polyisocyanates are 1,2,4-benzene triisocyanate polymethylene polyphenyl isocyanate, and isocyanate trimers based on 1,6-hexamethylene diisocyanate or isophorone diisocyanate. As with the polyesters, the polyurethanes can be prepared with unreacted carboxylic acid groups, which upon neutralization with bases such as amines allows for dispersion into aqueous medium.

Terminal and/or pendent carbamate functional groups can be incorporated into the polyurethane by reacting a polyisocyanate with a polymeric polyol containing the terminal/pendent carbamate groups. Alternatively, carbamate functional groups can be incorporated into the polyurethane by reacting a polyisocyanate with a polyol and a hydroxyalkyl carbamate or isocyanic acid as separate reactants. Carbamate functional groups can also be incorporated into the polyurethane by reacting a hydroxyl functional polyurethane with a low molecular weight carbamate functional material via a transcarbamoylation process similar to the one described above in connection with the incorporation of carbamate groups into the acrylic polymer. Additionally, an isocyanate functional polyurethane can be reacted with a hydroxyalkyl carbamate to yield a carbamate functional polyurethane.

Other functional groups such as amide, thiol, urea, or others listed above may be incorporated into the polyurethane as desired using suitably functional reactants if available, or conversion reactions as necessary to yield the desired functional groups. Such techniques are known to those skilled in the art.

Examples of polyether polyols are polyalkylene ether polyols which include those having the following structural formula:

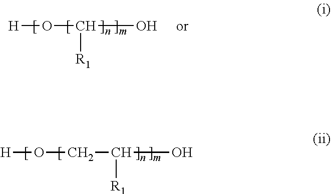

wherein the substituent R₁ is independently for each occurrence hydrogen or lower alkyl containing from 1 to 5 carbon atoms, and n is typically from 2 to 6 and m is from 8 to 100 or higher. Included are poly(oxytetramethylene)glycols, poly(oxytetraethylene) glycols, poly(oxy-1,2-propylene) glycols, and poly(oxy-1,2-butylene) glycols.

Also useful are polyether polyols formed from oxyalkylation of various polyols, for example, diols such as ethylene glycol, 1,6-hexanediol, Bisphenol A and the like, or other higher polyols such as trimethylolpropane, pentaerythritol, and the like. Polyols of higher functionality which can be utilized as indicated can be made, for instance, by oxyalkylation of compounds such as sucrose or sorbitol. One commonly utilized oxyalkylation method is reaction of a polyol with an alkylene oxide, for example, propylene or ethylene oxide, in the presence of an acidic or basic catalyst. Particular polyethers include those sold under the names TERATHANE and TERACOL, available from Invista, and POLYMEG, available from Lyondell Chemical Co.

Pendant carbamate functional groups may be incorporated into the polyethers by a transcarbamoylation reaction. Other functional groups such as acid, amine, epoxide, amide, thiol, and urea may be incorporated into the polyether as desired using suitably functional reactants if available, or conversion reactions as necessary to yield the desired functional groups. Examples of suitable amine functional polyethers include those sold under the name JEFFAMINE, such as JEFFAMINE D2000, a polyether functional diamine available from Huntsman Corporation.

Suitable epoxy functional polymers for use as the resin component (a) may include a polyepoxide chain extended by reacting together a polyepoxide and a polyhydroxyl group-containing material selected from alcoholic hydroxyl group-containing materials and phenolic hydroxyl group-containing materials to chain extend or build the molecular weight of the polyepoxide.

A chain extended polyepoxide is typically prepared by reacting together the polyepoxide and polyhydroxyl group-containing material neat or in the presence of an inert organic solvent such as a ketone, including methyl isobutyl ketone and methyl amyl ketone, aromatics such as toluene and xylene, and glycol ethers such as the dimethyl ether of diethylene glycol. The reaction is usually conducted at a temperature of about 80° C. to 160° C. for about 30 to 180 minutes until an epoxy group-containing resinous reaction product is obtained.

The equivalent ratio of reactants, i.e., epoxy: polyhydroxyl group-containing material is typically from about 1.00:0.75 to 1.00:2.00.

The polyepoxide by definition has at least two 1,2-epoxy groups. In general, the epoxide equivalent weight of the polyepoxide will range from 100 to about 2000, typically from about 180 to 500. The epoxy compounds may be saturated or unsaturated, cyclic or acyclic, aliphatic, alicyclic, aromatic or heterocyclic. They may contain substituents such as halogen, hydroxyl, and ether groups.

Examples of polyepoxides are those having a 1,2-epoxy equivalency of at least two, usually about two; that is, polyepoxides which have on average two epoxide groups per molecule. The most commonly used polyepoxides are polyglycidyl ethers of cyclic polyols, for example, polyglycidyl ethers of polyhydric phenols such as Bisphenol A, resorcinol, hydroquinone, benzenedimethanol, phloroglucinol, and catechol; or polyglycidyl ethers of polyhydric alcohols such as alicyclic polyols, particularly cycloaliphatic polyols such as 1,2-cyclohexane diol, 1,4-cyclohexane diol, 2,2-bis(4-hydroxycyclohexyl)propane, 1,1-bis(4-hydroxycyclohexyl)ethane, 2-methyl-1,1-bis(4-hydroxycyclohexyl)propane, 2,2-bis(4-hydroxy-3-tertiarybutylcyclohexyl)propane, 1,3-bis(hydroxymethyl)cyclohexane and 1,2-bis(hydroxymethyl)cyclohexane. Examples of aliphatic polyols include, inter alia, trimethylpentanediol and neopentyl glycol.

Polyhydroxyl group-containing materials used to chain extend or increase the molecular weight of the polyepoxide may additionally be polymeric polyols such as any of those disclosed above. The present disclosure may comprise epoxy resins such as diglycidyl ethers of Bisphenol A, Bisphenol F, glycerol, novolacs, and the like. Exemplary suitable polyepoxides are described in U.S. Pat. No. 4,681,811 at column 5, lines 33 to 58, the cited portion of which is incorporated by reference herein. Epoxy resin may also refer to polymers derived from epoxy-containing polymers.

Epoxy functional film-forming polymers may alternatively be addition polymer comprising the residue of unsaturated monomers wherein at least one unsaturated monomer comprises an epoxide functional group. The addition polymers may comprise acrylic polymers prepared with epoxy functional monomers such as glycidyl acrylate, glycidyl methacrylate, allyl glycidyl ether, and methallyl glycidyl ether. Polyesters, polyurethanes, or polyamides prepared with glycidyl alcohols or glycidyl amines, or reacted with an epihalohydrin are also suitable epoxy functional resins. Epoxide functional groups may be incorporated into a resin by reacting hydroxyl groups on the resin with an epihalohydrin or dihalohydrin such as epichlorohydrin or dichlorohydrin in the presence of alkali.

Nonlimiting examples of suitable fluoropolymers include fluoroethylene-alkyl vinyl ether alternating copolymers (such as those described in U.S. Pat. No. 4,345,057) available from Asahi Glass Company under the name LUMIFLON; fluoroaliphatic polymeric esters commercially available from 3M of St. Paul, Minnesota under the name FLUORAD; and perfluorinated hydroxyl functional (meth)acrylate resins.

The amount of the film-forming polymer in the curable film-forming composition may range from 25 to 100% by weight, based on the total weight of binder solids in the curable film-forming composition. For example, the film-forming polymer may be present in an amount of at least 25% by weight, such as at least 40% by weight, such as at least 50% by weight, and may be present in an amount of no more than 100% by weight, such as no more than 95% by weight, such as no more than 90% by weight, such as no more than 85% by weight, based on the total weight of binder solids in the curable film-forming composition. Ranges of film-forming polymer may include, for example, 25% to 100% by weight, such as 40% to 100% by weight, such as 50% to 100% by weight, such as 25% to 95% by weight, such as 40% to 95% by weight, such as 50% to 95% by weight, such as 25% to 90% by weight, such as 40% to 90% by weight, such as 50% to 90% by weight, such as 25% to 85% by weight, such as 40% to 85% by weight, such as 50% to 85% by weight, based on the total weight of binder solids in the curable film-forming composition. As used herein, the term “binder solids” refers to the organic film-forming binder and any other resinous materials included in the composition.

Suitable curing agents (b) for use in the organic film-forming binder of the curable film-forming compositions of the present disclosure include aminoplasts, phenolic resin, amino resin, polyisocyanates, including blocked isocyanates, polyepoxides, beta-hydroxyalkylamides, alkylated carbamate resin, (meth)acrylate, polyacids, anhydrides, alkoxysilanes, organometallic acid-functional materials, polyamines, polyamides, polysulfides, polythiols, polyenes such as polyacrylates, polyols, polysilanes, aldimines, ketimines, or other blocked amines, and mixtures of any of the foregoing, and include those known in the art for any of these materials. The curing agent may comprise two or more functional groups per molecule. The terms “curing agent”, “crosslinking agent” and “crosslinker” are herein used interchangeably.

Useful aminoplasts can be obtained from the condensation reaction of formaldehyde with an amine or amide. Nonlimiting examples of amines or amides include melamine, urea and benzoguanamine.

Although condensation products obtained from the reaction of alcohols and formaldehyde with melamine, urea or benzoguanamine are most common, condensates with other amines or amides can be used. Formaldehyde is the most commonly used aldehyde, but other aldehydes such as acetaldehyde, crotonaldehyde, and benzaldehyde can also be used.

The aminoplast can contain imino and methylol groups. In certain instances, at least a portion of the methylol groups can be etherified with an alcohol to modify the cure response. Any monohydric alcohol like methanol, ethanol, n-butyl alcohol, isobutanol, and hexanol can be employed for this purpose. Nonlimiting examples of suitable aminoplast resins are commercially available from Allnex, under the trademark CYMEL and from INEOS under the trademark RESIMENE.

Other crosslinking agents suitable for use include polyisocyanate crosslinking agents. As used herein, the term “polyisocyanate” is intended to include blocked (or capped) polyisocyanates as well as unblocked polyisocyanates. The polyisocyanate can be aliphatic, aromatic, or a mixture thereof. Although higher polyisocyanates such as isocyanurates of diisocyanates are often used, diisocyanates can also be used. Isocyanate prepolymers, for example reaction products of polyisocyanates with polyols also can be used. Mixtures of polyisocyanate crosslinking agents can be used.

The polyisocyanate can be prepared from a variety of isocyanate-containing materials. Examples of suitable polyisocyanates include trimers prepared from the following diisocyanates: toluene diisocyanate, 4,4′-methylene-bis(cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and 4,4′-diphenylmethylene diisocyanate. In addition, blocked polyisocyanate prepolymers of various polyols such as polyester polyols can also be used.

Isocyanate groups may be capped or uncapped as desired. If the polyisocyanate is to be blocked or capped, any suitable aliphatic, cycloaliphatic, or aromatic alkyl monoalcohol or phenolic compound known to those skilled in the art can be used as a capping agent for the polyisocyanate. Examples of suitable blocking agents include those materials which would unblock at elevated temperatures such as lower aliphatic alcohols including methanol, ethanol, and n-butanol; cycloaliphatic alcohols such as cyclohexanol; aromatic-alkyl alcohols such as phenyl carbinol and methylphenyl carbinol; and phenolic compounds such as phenol itself and substituted phenols wherein the substituents do not affect coating operations, such as cresol and nitrophenol. Glycol ethers may also be used as capping agents. Suitable glycol ethers include ethylene glycol butyl ether, diethylene glycol butyl ether, ethylene glycol methyl ether and propylene glycol methyl ether. Other suitable capping agents include oximes such as methyl ethyl ketoxime, acetone oxime and cyclohexanone oxime, lactams such as epsilon-caprolactam, pyrazoles such as dimethyl pyrazole, and amines such as dibutyl amine.

Polyepoxides are suitable crosslinking agents for polymers having carboxylic acid groups and/or amine groups. Examples of suitable polyepoxides include low molecular weight polyepoxides such as 3,4-epoxycyclohexylmethyl 3,4-epoxycyclohexanecarboxylate and bis(3,4-epoxy-6-methylcyclohexyl-methyl) adipate. Higher molecular weight polyepoxides, including the polyglycidyl ethers of polyhydric phenols and alcohols described above, are also suitable as crosslinking agents.

Beta-hydroxyalkylamides are suitable curing agents for polymers having carboxylic acid groups. The beta-hydroxyalkylamides can be depicted structurally as follows:

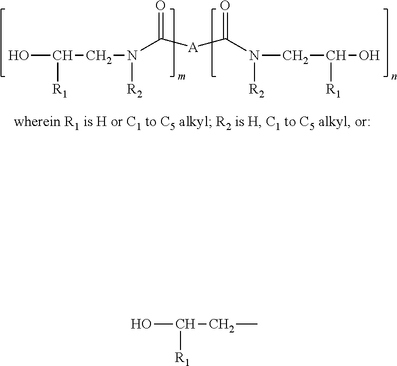

wherein R₁ is as described above; A is a bond or a polyvalent organic radical derived from a saturated, unsaturated, or aromatic hydrocarbon including substituted hydrocarbon radicals containing from 2 to 20 carbon atoms; m is equal to 1 or 2; n is equal to 0 or 2, and m+n is at least 2, usually within the range of from 2 up to and including 4. Most often, A is a C2 to C12 divalent alkylene radical.

Polyacids, particularly polycarboxylic acids, are suitable curing agents for polymers having epoxy functional groups. Examples of suitable polycarboxylic acids include adipic, succinic, sebacic, azelaic, and dodecanedioic acid. Other suitable polyacid crosslinking agents include acid group-containing acrylic polymers prepared from an ethylenically unsaturated monomer containing at least one carboxylic acid group and at least one ethylenically unsaturated monomer that is free from carboxylic acid groups. Such acid functional acrylic polymers can have an acid number ranging from 30 to 150. Acid functional group-containing polyesters can be used as well. Low molecular weight polyesters and half-acid esters can be used which are based on the condensation of aliphatic polyols with aliphatic and/or aromatic polycarboxylic acids or anhydrides. Examples of suitable aliphatic polyols include ethylene glycol, propylene glycol, butylene glycol, 1,6-hexanediol, trimethylol propane, di-trimethylol propane, neopentyl glycol, 1,4-cyclohexanedimethanol, pentaerythritol, and the like. The polycarboxylic acids and anhydrides may include, inter alia, terephthalic acid, isophthalic acid, phthalic acid, phthalic anhydride, tetrahydrophthalic acid, tetrahydrophthalic anhydride, hexahydrophthalic anhydride, methylhexahydrophthalic anhydride, chlorendic anhydride, and the like. Mixtures of acids and/or anhydrides may also be used. The above-described polyacid crosslinking agents are described in further detail in U.S. Pat. No. 4,681,811, at column 6, line 45 to column 9, line 54, which is incorporated herein by reference.

Nonlimiting examples of suitable polyamine crosslinking agents include primary or secondary diamines or polyamines in which the radicals attached to the nitrogen atoms can be saturated or unsaturated, aliphatic, alicyclic, aromatic, aromatic-substituted-aliphatic, aliphatic-substituted-aromatic, and heterocyclic. Nonlimiting examples of suitable aliphatic and alicyclic diamines include 1,2-ethylene diamine, 1,2-propylene diamine, 1,8-octane diamine, isophorone diamine, propane-2,2-cyclohexyl amine, and the like. Nonlimiting examples of suitable aromatic diamines include phenylene diamines and toluene diamines, for example o-phenylene diamine and p-tolylene diamine. Polynuclear aromatic diamines such as 4,4′-biphenyl diamine, methylene dianiline and monochloromethylene dianiline are also suitable.

Examples of suitable aliphatic diamines include, without limitation, ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diaminohexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′- and/or 4,4′-diamino-dicyclohexyl methane and 3,3′-dialkyl-4,4′-diamino-dicyclohexyl methanes (such as 3,3′-dimethyl-4,4′-diamino-dicyclohexyl methane and 3,3′-diethy-1-4,4′-diamino-dicyclohexyl methane), 2,4- and/or 2,6-diaminotoluene and 2,4′- and/or 4,4′-diaminodiphenyl methane, or mixtures thereof. Cycloaliphatic diamines are available commercially from Huntsman Corporation (Houston, TX) under the designation of JEFFLINK such as JEFFLINK 754. Additional aliphatic cyclic polyamines may also be used, such as DESMOPHEN NH 1520 available from Covestro AG and/or CLEARLINK 1000, which is a secondary aliphatic diamine available from Dorf Ketal. POLYCLEAR 136 (available from BASF/Hansen Group LLC), the reaction product of isophorone diamine and acrylonitrile, is also suitable. Other exemplary suitable polyamines are described in U.S. Pat. No. 4,046,729 at column 6, line 61 to column 7, line 26, and in U.S. Pat. No. 3,799,854 at column 3, lines 13 to 50, the cited portions of which are incorporated by reference herein. Additional polyamines may also be used, such as ANCAMINE polyamines, available from Evonik Industries.

Suitable polyenes include any of those known in the art. Suitable polyenes may include those that are represented by the formula:

$$A - {( {X}_{1} )}_{m}$$

wherein A is an organic moiety, X is an olefinically unsaturated moiety and m is at least 2, typically 2 to 6. Examples of X are groups of the following structure:

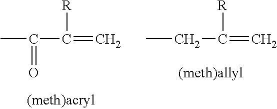

wherein each R is a radical selected from H and methyl.

The polyenes may be compounds or polymers having in the molecule olefinic double bonds that are polymerizable by exposure to radiation. Examples of such materials are (meth)acrylic-functional (meth)acrylic copolymers, epoxy resin (meth)acrylates, polyester (meth)acrylates, polyether (meth)acrylates, polyurethane (meth)acrylates, amino (meth)acrylates, silicone (meth)acrylates, and melamine (meth)acrylates. The number average molar mass (Mn) of these compounds is often around 200 to 10,000. The molecule often contains on average 2 to 20 olefinic double bonds that are polymerizable by exposure to radiation. Aliphatic and/or cycloaliphatic (meth)acrylates in each case are often used. (Cyclo)aliphatic polyurethane (meth)acrylates and (cyclo)aliphatic polyester (meth)acrylates are particularly suitable. The binders may be used singly or in mixture.

Specific examples of polyurethane (meth)acrylates are reaction products of the polyisocyanates such as 1,6-hexamethylene diisocyanate and/or isophorone diisocyanate including isocyanurate and biuret derivatives thereof with hydroxyalkyl (meth)acrylates such as hydroxyethyl (meth)acrylate and/or hydroxypropyl (meth)acrylate. The polyisocyanate can be reacted with the hydroxyalkyl (meth)acrylate in a 1:1 equivalent ratio or can be reacted with an NCO/OH equivalent ratio greater than 1 to form an NCO-containing reaction product that can then be chain extended with a polyol such as a diol or triol, for example 1,4-butane diol, 1,6-hexane diol and/or trimethylol propane. Examples of polyester (meth)acrylates are the reaction products of (meth)acrylic acid or anhydride with polyols, such as diols, triols and tetrols, including alkylated polyols, such as propoxylated diols and triols. Examples of polyols include 1,4-butane diol, 1,6-hexane diol, neopentyl glycol, trimethylol propane, pentaerythritol and propoxylated 1,6-hexane diol. Specific examples of polyester (meth)acrylate are glycerol tri(meth)acrylate, trimethylolpropane tri(meth)acrylate, pentaerythritol tri(meth)acrylate and pentaerythritol tetra(meth)acrylate.

Besides (meth)acrylates, (meth)allyl compounds or polymers can be used either alone or in combination with (meth)acrylates. Examples of (meth)allyl materials are polyallyl ethers such as the diallyl ether of 1,4-butane diol and the triallyl ether of trimethylol propane. Examples of other (meth)allyl materials are polyurethanes containing (meth)allyl groups. For example, reaction products of the polyisocyanates such as 1,6-hexamethylene diisocyanate and/or isophorone diisocyanate including isocyanurate and biuret derivatives thereof with hydroxyl-functional allyl ethers, such as the monoallyl ether of 1,4-butane diol and the diallylether of trimethylol propane. The polyisocyanate can be reacted with the hydroxyl-functional allyl ether in a 1:1 equivalent ratio or can be reacted with an NCO/OH equivalent ratio greater than 1 to form an NCO-containing reaction product that can then be chain extended with a polyol such as a diol or triol, for example 1,4-butane diol, 1,6-hexane diol and/or trimethylol propane.

As used herein the term “polythiol functional material” refers to polyfunctional materials containing two or more thiol functional groups (SH). Suitable polythiol functional materials for use in forming the curable film-forming composition are numerous and can vary widely. Such polythiol functional materials can include those that are known in the art. Non-limiting examples of suitable polythiol functional materials can include polythiols having at least two thiol groups including compounds and polymers. The polythiol can have ether linkages (—O—), sulfide linkages (—S—), including polysulfide linkages (-Sx-), wherein x is at least 2, such as from 2 to 4, and combinations of such linkages.

The polythiols for use in the present disclosure include materials of the formula:

$${R}^{1} - {( SH )}_{n}$$

wherein R¹ is a polyvalent organic moiety and n is an integer of at least 2, typically 2 to 6.

Non-limiting examples of suitable polythiols include esters of thiol-containing acids of the formula HS—R²—COOH wherein R² is an organic moiety with polyhydroxy compounds of the structure R³—(OH)ₙ wherein R³ is an organic moiety and n is at least 2, typically 2 to 6. These components can be reacted under suitable conditions to give polythiols having the general structure:

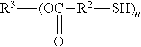

wherein R², R³ and n are as defined above.

Examples of thiol-containing acids are thioglycolic acid (HS—CH₂COOH), α-mercaptopropionic acid (HS—CH(CH₃)—COOH) and β-mercaptopropionic acid (HS—CH₂CH₂COOH) with polyhydroxy compounds such as glycols, triols, tetrols, pentaols, hexaols, and mixtures thereof. Other non-limiting examples of suitable polythiols include ethylene glycol bis(thioglycolate), ethylene glycol bis(P-mercaptopropionate), trimethylolpropane tris(thioglycolate), trimethylolpropane tris(β-mercaptopropionate), pentaerythritol tetrakis (thioglycolate) and pentaerythritol tetrakis(β-mercaptopropionate), and mixtures thereof.

Suitable polyacids and polyols useful as curing agents include any of those known in the art, such as those described herein for the making of polyesters.

Appropriate mixtures of curing agents may also be used in the disclosure. The amount of the curing agent in the curable film-forming composition may range from 5% to 75% by weight, based on the total weight of binder solids in the curable film-forming composition. For example, the curing agent may be present in an amount of at least 5% by weight, such as at least 10% by weight, such as at least 15% by weight, and may be present in an amount of no more than may be 75% by weight, such as no more than 60% by weight, such as no more than 50% by weight, based on the total weight of binder solids in the curable film-forming composition. Ranges of curing agent may be, for example, 5% to 75% by weight, such as 5% to 60% by weight, such as 10% to 75% by weight, such as 10% to 60% by weight, such as 10% to 50% by weight, such as 15% to 75% by weight, such as 15% to 60% by weight, such as 15% to 50% by weight, based on the total weight of binder solids in the curable film-forming composition.

The resin component (a) may comprise epoxide functional groups and the curing agent component (b) may comprise amino functional groups.

The organic film-forming binder may be present in the first coating or first coating composition in an amount of at least 5% by weight, such as at least 10% by weight, such as at least 15% by weight, such as 20% by weight, based on the total weight of the first coating or the total solids weight of the first coating composition. The organic film-forming binder may be present in the first coating or first coating composition in an amount of no more than 25% by weight, such as no more than 20% by weight, such as no more than 15% by weight, such as no more than 10% by weight, such as no more than 5% by weight, based on the total weight of the first coating or the total solids weight of the first coating composition. The organic film-forming binder may be present in the first coating or first coating composition in an amount of 5% to 25% by weight, such as 5% to 20% by weight, such as 5% to 15% by weight, such as 5% to 10% by weight, 10% to 25% by weight, such as 10% to 20% by weight, such as 10% to 15% by weight, such as 15% to 25% by weight, such as 15% to 20% by weight, 20% to 25% by weight, based on the total weight of the first coating or the total solids weight of the first coating composition.

According to the present disclosure, the first coating or first coating composition may also be substantially free, essentially free, or completely free of any of the film-forming polymers or curing agents described above.

According to the present disclosure, the binder may comprise an inorganic binder. As used herein, a binder will be considered to be an “inorganic” if the binder comprises inorganic-based materials present in an amount of greater than 50% by weight, based on the total weight of the total binder composition, such as at least 51% by weight, such as at least 75% by weight, such as at least 85% by weight, such as at least 95% by weight, such as at least 99% by weight, such as 100% by weight, based on the total weight of the binder. As used herein, the term “total weight of the binder” refers to the total weight of all materials present in the composition that are intended to react during cure to crosslink the binder. The inorganic binder may comprise 51% to 100% by weight of inorganic-based materials, such as 75% to 100% by weight, such as 85% to 100% by weight, such as 95% to 100% by weight, such as 99% to 100% by weight, such as 100% by weight, based on the total weight of the binder. The remainder of the binder may comprise organic materials present in an amount of less than 50% by weight, based on the total weight of the binder. Non-limiting examples of inorganic binders includes titanates, silicates, and the like.

The inorganic binder may be present in the first coating or first coating composition in an amount of at least 5% by weight, such as at least 10% by weight, based on the total weight of the first coating or the total solids weight of the first coating composition. The inorganic binder may be present in the first coating or first coating composition in an amount of no more than 15% by weight, such as no more than 10% by weight, such as no more than 5% by weight, based on the total weight of the first coating or the total solids weight of the first coating composition. The inorganic binder may be present in the first coating or first coating composition in an amount of 5% to 15% by weight, such as 5% to 10% by weight, such as 10% to 15% by weight, based on the total weight of the first coating or the total solids weight of the first coating composition.

According to the present disclosure, the first coating or first coating composition may be substantially free, essentially free, or completely free of inorganic binders.

According to the present disclosure, the first coating or first coating composition may be substantially free, essentially free, or completely free of organic film-forming binders.

According to the present disclosure, the first coating layer may have a dry film thickness of at least 2 mils, such as at least 2.5 mils. The first coating layer may have a dry film thickness of no more than 8 mils, such as no more than 4 mils, such as no more than 3 mils, such as no more than 2.5 mils. The first coating layer may have a dry film thickness of 2 to 8 mils, such as 2 to 4 mils, such as 2 to 3 mils, such as 2 to 2.5 mils, such as 2.5 to 8 mils, such as 2.5 to 4 mils, such as 2.5 to 3 mils. As used herein, the dry film thickness with reference to the first coating layer is measured over the profile of the surface of the substrate.

### Second Coating/Second Coating Composition

According to the present disclosure, the coated metal substrate comprises a second coating layer comprising aluminum particles, an alkaline earth metal compound, and a second organic film-forming binder.

According to the present disclosure, the system for coating a metal substrate comprises a second coating composition comprising aluminum particles, an alkaline earth metal compound, and a second organic film-forming binder.

The aluminum particles may comprise aluminum metal, aluminum alloy, or any combination thereof. Some non-limiting examples of aluminum particles are described in U.S. Pat. Nos. 8,262,938, 8,277,688, 9,243,333. U.S. Pat. Nos. 9,243,150, 9,534,120, and U.S. application Ser. No. 14/950,835, each of which are incorporated herein by reference.

As used herein, the terms “aluminum metal” or “aluminum metal particles” when referring to metal particles refers to metal particles comprising at least 92% metallic aluminum with the rest of the particle including impurities in the form of other metals or metal oxides, such as, for example, metal particles marketed as aluminum powder or aluminum dust, and includes metal particles having up to 100% metallic aluminum. As used herein, an “aluminum alloy” or “aluminum alloy particles” refers to an alloy having aluminum as the predominant metal, such as an alloy comprising at least 50% by weight of aluminum, based on the total weight of the aluminum alloy.

The aluminum particles may be subjected to a surface treatment to modify the surface of the metal particle. The surface treated metal particles may comprise a pretreatment layer formed by exposing the metal particle to a pretreatment composition. As used herein, the term “pretreatment composition” refers to a composition that upon contact with the substrate reacts with and chemically alters the substrate surface and binds to it to form a protective layer. The pretreatment composition used to modify the surface of the metal particles may comprise any known in the art for pretreating metal substrates. For example, suitable pretreatment compositions include, but are not limited to, zinc phosphate pretreatment compositions, such as, for example, those described in U.S. Pat. Nos. 4,793,867 and 5.588,989, or zirconium-containing pretreatment compositions, such as, for example, those described in U.S. Pat. Nos. 7,749,368 and 8,673,091. Other non-limiting examples of a pretreatment composition include those comprising trivalent chromium, hexavalent chromium, lithium salts, permanganate, rare earth metals, such as yttrium, or lanthanides, such as cerium. Another non-limiting example of a suitable surface pretreatment solution is a solgel, such as those comprising alkoxy-silanes, alkoxy-zirconates, and/or alkoxy-titanates.

The aluminum particles may have an average particle size of at least 1 micron, such as at least 2 microns, at least 4 microns, such as at least 5 microns, such as at least 6 microns, such as at least 10 microns. The aluminum particles may have an average particle size of no more than 150 microns, such as no more than 28 microns, such as no more than 20 microns, such as no more than 12 microns, such as no more than 10 microns, such as no more than 8 microns. The aluminum particles may have an average particle size of 1 to 150 microns, such as 1 to 28 microns, such as 1 to 20 microns, such as 1 to 12 microns, such as 1 to 10 microns, such as 1 to 8 microns, such as 2 to 28 microns, such as 2 to 20 microns, such as 2 to 12 microns, such as 2 to 10 microns, such as 2 to 8 microns, such as 4 to 28 microns, such as 4 to 20 microns, such as 4 to 12 microns, such as 4 to 10 microns, such as 4 to 8 microns, such as 5 to 28 microns, such as 5 to 20 microns, such as 5 to 12 microns, such as 5 to 10 microns, such as 5 to 8 microns, such as 6 to 28 microns, such as 6 to 20 microns, such as 6 to 12 microns, such as 6 to 10 microns, such as 6 to 8 microns, such as 1 to 28 microns, such as 10 to 20 microns, such as 10 to 12 microns. The particle size selected may be dependent upon the thickness of the desired coating. For example, thin coatings may require smaller particle sizes, while thicker coatings could tolerate larger particles. The average particle size as reported herein is the average particle size as provided by the metal particulate manufacturer and may be measured by various methods known in the art, such as, for example, laser diffraction.

The second coating or second coating composition may comprise at least 5% by weight aluminum particles, such as at least 10% by weight, such as at least 15% by weight, such as at least 20% by weight, such as at least 30% by weight, such as at least 40% by weight, based on the total weight of the second coating or the total solids weight of the second coating composition. The second coating or second coating composition may comprise no more than 50% by weight aluminum particles, such as no more than 45% by weight, such as no more than 40% by weight, such as no more than 35% by weight, such as no more than 30% by weight, such as no more than 25% by weight, such as no more than 20% by weight, such as no more than 15% by weight, such as no more than 10% by weight, based on the total weight of the second coating or the total solids weight of the second coating composition. The second coating or second coating composition may comprise 5% to 50% by weight aluminum particles, such as 5% to 45% by weight, such as 5% to 40% by weight, such as 5% to 35% by weight, such as 5% to 30% by weight, such as 5% to 25% by weight, such as 5% to 20% by weight, such as 5% to 15% by weight, such as 5% to 10% by weight, such as 10% to 50% by weight, such as 10% to 45% by weight, such as 10% to 40% by weight, such as 10% to 35% by weight, such as 10% to 30% by weight, such as 10% to 25% by weight, such as 10% to 20% by weight, such as 10% to 15% by weight, such as 15% to 50% by weight, such as 15% to 45% by weight, such as 15% to 40% by weight, such as 15% to 35% by weight, such as 15% to 30% by weight, such as 15% to 25% by weight, such as 15% to 20% by weight, such as 20% to 50% by weight, such as 20% to 45% by weight, such as 20% to 40% by weight, such as 20% to 35% by weight, such as 20% to 30% by weight, such as 20% to 25% by weight, such as 25% to 50% by weight, such as 25% to 45% by weight, such as 25% to 40% by weight, such as 25% to 35% by weight, such as 25% to 30% by weight, such as 30% to 50% by weight, such as 30% to 45% by weight, such as 30% to 40% by weight, such as 30% to 35% by weight, such as 35% to 50% by weight, such as 35% to 45% by weight, such as 35% to 40% by weight, such as 40% to 50% by weight, such as 40% to 45% by weight, such as 45% to 50% by weight, based on the total weight of the second coating or the total solids weight of the second coating composition.

According to the present disclosure, the second coating and second coating composition comprises an alkaline earth metal compound. As used herein, an alkaline earth metal compound refers to compounds that comprise an alkaline earth metal in the +2-oxidation state and specifically excludes metals comprising elemental (zerovalent) alkaline earth metal. The alkaline earth metal compound may comprise beryllium, magnesium, calcium, strontium, barium, or combinations thereof. The alkaline earth metal may comprise, consist essentially of, or consist of an oxide, carbonate, hydroxide, sulfate, monocarboxylate, or phosphate of an alkaline earth metal, or combinations thereof. For example, the alkaline earth metal may comprise, consist of, or consist essentially of magnesium oxide, magnesium carbonate, magnesium hydroxide, magnesium sulfate, magnesium monocarboxylate (e.g., magnesium stearate), magnesium phosphate, calcium oxide, calcium carbonate, calcium hydroxide, calcium sulfate, calcium monocarboxylate, calcium phosphate, strontium oxide, strontium carbonate, strontium hydroxide, strontium sulfate, strontium monocarboxylate, strontium phosphate, barium oxide, barium carbonate, barium hydroxide, barium sulfate, barium monocarboxylate, barium phosphate, beryllium oxide, beryllium carbonate, beryllium hydroxide, beryllium sulfate, beryllium monocarboxylate, beryllium phosphate, or combinations thereof. It should be understood that the alkaline earth metal compound is separate and distinct from any metal oxidation products that may be found on the surface of the metal particles.

The alkaline earth metal compound may have any suitable average particle size according to the present disclosure. For example, the alkaline earth metal compound may be micron sized, such as 0.5 to 50 microns, such as 1 to 15 microns, such as 5 to 15 microns, with size based on average particle size. For example, the alkaline earth metal compound may be nano sized, such as 10 to 499 nanometers, such as 10 to 100 nanometers, such as 15 to 50 nanometers, with size based on average particle size. Various coating composition preparation methods may result in the alkaline earth metal compound particles agglomerating, which could increase average particle size, or shearing or other action that can reduce average particle size.

The alkaline earth metal compound of the present disclosure may comprise ultrafine alkaline earth metal compound particles. As used herein, the term “ultrafine” refers to particles that have a B.E.T. specific surface area of at least 10 square meters per gram, such as 30 to 500 square meters per gram, such as 80 to 250 square meters per gram. As used herein, the term “B.E.T. specific surface area” refers to a specific surface area determined by nitrogen adsorption according to the ASTMD 3663-78 standard based on the Brunauer-Emmett-Teller method described in the periodical “The Journal of the American Chemical Society”, 60, 309 (1938).

The alkaline earth metal compound of the present disclosure may comprise alkaline earth metal compound particles having a calculated equivalent spherical diameter of no more than 200 nanometers, such as no more than 100 nanometers, such as 5 to 50 nanometers. As will be understood by those skilled in the art, a calculated equivalent spherical diameter can be determined from the B.E.T. specific surface area according to the following equation: Diameter (nanometers)=6000/[BET (m²/g)*p (grams/cm³)].

The alkaline earth metal compound of the present disclosure may comprise particles having an average primary particle size of no more than 100 nanometers, such as no more than 50 nanometers, such as no more than 25 nanometers, as determined by visually examining a micrograph of a transmission electron microscopy (“TEM”) image, measuring the diameter of the particles in the image, and calculating the average primary particle size of the measured particles based on magnification of the TEM image. One of ordinary skill in the art will understand how to prepare such a TEM image and determine the primary particle size based on the magnification. The primary particle size of a particle refers to the smallest diameter sphere that will completely enclose the particle. As used herein, the term “primary particle size” refers to the size of an individual particle as opposed to an agglomeration of two or more individual particles.

The alkaline earth metal compound of the present disclosure may comprise particles having a geometry where at least one particle axis is no more than 200 nm, such no more than 100 nm, such as no more than 50 nm, such as no more than 25 nm. As used herein, the term “particle axis” refers to a straight-line distance from one distinct edge of the particle to another, such as the length, width, height, diameter, or any measurement from one edge to another where the measurement passes through the center of the particle.

The alkaline earth metal particles may have an affinity for the medium (e.g., solvent) of the coating composition sufficient to keep the particles suspended therein, wherein the affinity of the particles for the medium is greater than the affinity of the particles for each other, thereby reducing or eliminating agglomeration of the particles within the medium.

The shape (or morphology) of the alkaline earth metal particles may vary. For example, generally spherical morphologies may be used, as well as particles that are cubic, platy, polyhedric, or acicular (elongated or fibrous). The particles may be covered completely in a polymeric gel, not covered at all in a polymeric gel, or covered partially with a polymeric gel. As used herein, covered partially with a polymeric gel means that at least some portion of the particle has a polymeric gel deposited thereon, which, for example, may be covalently bonded to the particle or merely associated with the particle.

The second coating or second coating composition may comprise at least 0.5% by weight alkaline earth metal compound, such as at least 1% by weight alkaline earth metal compound, such as at least 2% by weight alkaline earth metal compound, such as at least 3% by weight, such as at least 5% by weight, such as at least 6% by weight, based on the total weight of the second coating or total solids weight of the second coating composition. The second coating or second coating composition may comprise no more than 50% by weight alkaline earth metal compound, such as no more than 25% by weight, such as no more than 20% by weight, such as no more than 18% by weight, based on the total weight of the second coating or total solids weight of the second coating composition. The second coating or second coating composition may comprise 0.5% to 50% by weight alkaline earth metal compound, such as 0.5% to 25% by weight, such as 0.5% to 20% by weight, such as 0.5% to 18% by weight, such as 1% to 50% by weight, such as 1% to 25% by weight, such as 1% to 20% by weight, such as 1% to 18% by weight, such as 2% to 50% by weight, such as 2% to 25% by weight, such as 2% to 20% by weight, such as 2% to 18% by weight, such as 3% to 50% by weight, such as 3% to 25% by weight, such as 3% to 20% by weight, such as 3% to 18% by weight, such as 5% to 50% by weight, such as 5% to 25% by weight, such as 5% to 20% by weight, such as 5% to 18% by weight, such as 6% to 50% by weight, such as 6% to 25% by weight, such as 6% to 20% by weight, such as 6% to 18% by weight, based on the total weight of the second coating or total solids weight of the second coating composition.

According to the present disclosure, the second coating or second coating composition may be substantially free, essentially free, or completely free of any of the specific alkaline earth metal compounds described above. For example, the second coating or second coating composition may be substantially free, essentially free, or completely free of magnesium oxide, magnesium carbonate, magnesium hydroxide, magnesium sulfate, magnesium monocarboxylate (e.g., magnesium stearate), magnesium phosphate, calcium oxide, calcium carbonate, calcium hydroxide, calcium sulfate, calcium monocarboxylate, calcium phosphate, strontium oxide, strontium carbonate, strontium hydroxide, strontium sulfate, strontium monocarboxylate, strontium phosphate, barium oxide, barium carbonate, barium hydroxide, barium sulfate, barium monocarboxylate, barium phosphate, beryllium oxide, beryllium carbonate, beryllium hydroxide, beryllium sulfate, beryllium monocarboxylate, and/or beryllium phosphate.

According to the present disclosure, the second coating and second coating composition further comprises a second organic film-forming binder. The second organic film-forming binder may comprise any of the organic film-forming binders described above with respect to the first coating and first coating composition.

The organic film-forming binder may be present in the second coating or second coating composition in an amount of at least 10% by weight, such as 20% by weight, such as at least 30% by weight, such as at least 40% by weight, such as at least 50% by weight, based on the total weight of the second coating or the total solids weight of the second coating composition. The organic film-forming binder may be present in the second coating or second coating composition in an amount of no more than 94.5% by weight, such as no more than 75% by weight, such as no more than 60% by weight, such as no more than 45% by weight, such as no more than 30% by weight, based on the total weight of the second coating or the total solids weight of the second coating composition. The organic film-forming binder may be present in the first coating or first coating composition in an amount of 10% to 94.5% by weight, such as 10% to 75% by weight, such as 10% to 60% by weight, such as 10% to 45% by weight, such as 10% to 30% by weight, such as 20% to 94.5% by weight, such as 20% to 75% by weight, such as 20% to 60% by weight, such as 20% to 45% by weight, such as 20% to 30% by weight, such as 30% to 94.5% by weight, such as 30% to 75% by weight, such as 30% to 60% by weight, such as 30% to 45% by weight, such as 40% to 94.5% by weight, such as 40% to 75% by weight, such as 40% to 60% by weight, such as 40% to 45% by weight, such as 40% to 94.5% by weight, such as 40% to 75% by weight, such as 40% to 60% by weight, such as 40% to 45% by weight, such as 50% to 94.5% by weight, such as 50% to 75% by weight, such as 50% to 60% by weight, based on the total weight of the first coating or the total solids weight of the first coating composition.

According to the present disclosure, the second coating or second coating composition may also be substantially free, essentially free, or completely free of any of the film-forming polymers or curing agents described above.

According to the present disclosure, the second coating or second coating composition may be substantially free, essentially free, or completely free of inorganic binders.

According to the present disclosure, the second coating or second coating composition may optionally further comprise an aldehyde and/or ketone component comprising at least one aromatic ring comprising a ketone and/or aldehyde group and at least one pendant group represented by —OR¹, wherein each R¹ is independently selected from hydrogen, an alkyl group, or an aryl group. An “aldehyde component” refers to a monomer comprising at least one aldehyde group —C(═O)H, and a “ketone component” refers to a monomer comprising a ketone group —C(═O)R², where R² is a carbon-containing substituent including, but not limited to, an alkyl group or an aryl group, which are defined in further detail herein. The aldehyde and/or a ketone component also includes a non-volatile aldehyde and/or a ketone component. A “non-volatile aldehyde component” and “non-volatile ketone component” refers to an aldehyde and ketone component with a vapor pressure that is 140 pascals (Pa) or less at 25° C., as determined by ASTM D2879-10. Volatile components that are typically removed from the composition during cure and which are not used as a non-volatile aldehyde and/or a ketone component include, but are not limited to, acetone, methyl amyl ketone, methyl ethyl ketone, methyl propyl ketone, methyl isoamyl ketone, cyclohexanone, diacetone alcohol, methyl isobutyl ketone, diisobutyl ketone, diisoamyl ketone, diamyl ketone, isophorone, pentoxone, and C-11 ketone.

The aldehyde and/or ketone component can have a calculated molecular weight of less than 500 g/mole. The aldehyde and/or ketone component can also have a calculated molecular weight of less than 400 g/mole or less 300 g/mole. As will be understood by those skilled in the art, a calculated molecular weight is the sum of the atomic weights of each constituent element multiplied by the number of atoms of that element in the molecular formula.

Further, the aldehyde and/or ketone component used with the present disclosure comprises at least one aromatic ring comprising an aldehyde group and/or a ketone group. Thus, the aldehyde and/or ketone component comprises at least one aromatic ring having an aldehyde group represented by —C(═O)H, and/or a ketone group represented by —C(═O)R² in which R² is a carbon-containing substituent including, but not limited to, an alkyl group or an aryl group, which are defined in further detail herein. As used herein, the term “aromatic” refers to a cyclically conjugated hydrocarbon with a stability (due to delocalization) that is significantly greater than that of a hypothetical localized structure. The aromatic ring can include aromatic carbocyclic or heteroaromatic ring structures. An “aromatic carbocyclic ring” refers to an aromatic ring with the aromatic group completely formed by bonded carbon atoms, and a “heteroaromatic ring” refers to an aromatic ring with at least one carbon atom of the aromatic group replaced by a heteroatom such as nitrogen, oxygen, sulfur, or a combination thereof.

In addition, the aromatic ring structure can comprise a monocyclic aromatic ring, a bicyclic aromatic ring, a polycyclic aromatic ring, or a combination thereof. A “monocyclic aromatic ring” refers to a single aromatic cyclic ring containing 3 to 18 carbon atoms such as 5 to 6 carbon atoms (i.e., a 5- or 6-membered ring). A “bicyclic aromatic ring” refers to two aromatic rings, each aromatic ring independently containing 3 to 18 carbon atoms such as 5 to 6 carbon atoms, in which one, two, or more atoms are shared between the two aromatic rings. A “polycyclic aromatic ring” refers to three or more aromatic rings, each aromatic ring independently containing 3 to 18 carbon atoms such as 5 to 6 carbon atoms, in which one, two, or more atoms of each aromatic ring are shared with at least one other aromatic ring that forms the polycyclic structure. It is appreciated that two or more monocyclic, bicyclic, and/or polycyclic aromatic rings can be used alone or bonded together to form the aldehyde and/or ketone component.

As previously described, the aldehyde and/or ketone component used with the present disclosure comprises an aromatic ring having an aldehyde and/or ketone group. A ketone group can be part of the aromatic ring or an aldehyde and/or ketone group can be bonded to the aromatic ring as a pendant group (i.e., a chemical group other than hydrogen that is attached to and extends out from the aromatic ring). The aldehyde and/or ketone component also comprises at least one other pendant group bonded to the aromatic ring that is represented by —OR¹ in which each R¹ is independently selected form an alkyl group, hydrogen, or aryl group. In some instances, the aldehyde and/or ketone component does not include carboxylic acid groups (i.e., is completely free of carboxylic acid groups).

The term “alkyl” as used herein refers to an aliphatic (i.e., non-aromatic) linear, branched, and/or cyclic monovalent hydrocarbon radical. The alkyl group may include, but is not limited to, an aliphatic linear or branched C₁-C₃₀ monovalent hydrocarbon radical, or an aliphatic linear or branched C₁-C₂₀ monovalent hydrocarbon radical, or an aliphatic linear or branched C₁-C₁₀ monovalent hydrocarbon radical. The alkyl group may also include, but is not limited to, an aliphatic cyclic C₃-C₁₉ monovalent hydrocarbon radical, or an aliphatic cyclic C₃-C₁₂ monovalent hydrocarbon radical, or an aliphatic cyclic C₅-C₇ monovalent hydrocarbon radical.

Recitations of “linear, branched, or cyclic” groups, such as linear, branched, or cyclic alkyl are herein understood to include: a monovalent methyl group; groups that are linear, such as straight-chained C₂-C₃₀ alkyl groups; groups that are appropriately branched, such as branched C₃-C₃₀ alkyl groups, refers to an alkyl chain with a hydrogen replaced by a substituent such as an alkyl group that branches or extends out from a straight alkyl chain; and groups that are cyclic, such as cyclic C₃-C₁₉ alkyl groups, refers to a closed ring structure.

The alkyl group can be unsubstituted or substituted. A substituted alkyl group refers to an alkyl group where at least one hydrogen thereof has been optionally replaced or substituted with a group that is other than hydrogen. Such groups can include, but are not limited to, halo groups (e.g., F, Cl, I, and Br), hydroxyl groups, ether groups, thiol groups, thio ether groups, carboxylic acid groups, carboxylic acid ester groups, phosphoric acid groups, phosphoric acid ester groups, sulfonic acid groups, sulfonic acid ester groups, nitro groups, cyano groups, and alkyl groups present as sidechains, for example.

The term “aryl” refers to a substituent derived from an aromatic ring, such as a phenyl group for example. The aryl group can be derived from a monocyclic aromatic ring, a bicyclic aromatic ring, or a polycyclic aromatic ring. The aryl group can also include a heteroaryl group in which at least one carbon atom of the aromatic group is replaced by a heteroatom such as nitrogen, oxygen, sulfur, or a combination thereof. The aryl group can also include a substituted aryl group where at least one hydrogen thereof has been optionally replaced or substituted with a group that is other than hydrogen. Such groups can include, but are not limited to, any of the substituted groups previously described.

The aldehyde and/or ketone component can comprise at least one, at least two, at least three, or at least four additional pendant groups bonded to the aromatic ring that are represented by —OR¹ as defined above. For example, the aldehyde and/or ketone component used with the present disclosure can comprise an aromatic ring having an aldehyde and/or ketone group and two pendant groups represented by —OR¹ in which R¹ is a hydrogen for one of the pendant groups and an alkyl group for the second pendant group. As such, the aldehyde and/or ketone component used with the present disclosure can comprise an aromatic ring having an aldehyde and/or ketone group, a pendant hydroxyl group (—OH), and a pendant alkoxy group (—O-alkyl). It is appreciated that the pendant groups represented by —OR¹ can be bonded to multiple aromatic rings such as when a bicyclic or polycyclic aromatic ring is used or when multiple monocyclic rings are used.

The aromatic ring(s) of the aldehyde and/or ketone component may be further substituted with one or more groups different from those described above. Such groups can include, but are not limited to, alkyl groups, aryl groups, and other optional substituted groups as previously defined.

Non-limiting examples of aldehyde components that can be used include 2-hydroxybenzaldehyde, 3,5-di-tert-butyl-2-hydroxybenzaldehyde, 2-hydroxy-1-napthaldehyde, 2-hydroxy-3-methoxybenzaldehyde, 2-hydroxy-3-ethoxybenzaldehyde, 2-hydroxy-4-methoxybenzaldehyde, 2,3-dihydroxybenzaldehyde, 2,4-dihydroxybenzaldehyde, 3-methoxy-4-hydroxybenzaldehyde, 3,5-methoxy-4-hydroxybenzaldehyde, 3,4-dihydroxybenzaldehyde, and combinations thereof.

Non-limiting examples of ketone components that can be used include maltol, 2,4-dihydroxybenzophenone, 2-hydroxy-4-methoxybenzophenone, 2-hydroxy-4-n-octoxybenzophenone, 2,2′,4,4′-tetrahydroxybenzophenone, and combinations thereof. It is appreciated that a ketone component can be used with or without an aldehyde component.

The aldehyde and/or ketone component may be present in the second coating or second film-forming coating composition in an amount of 0.7% to 25% by weight, such as 1% to 10% by weight, based on the total weight of the second coating or the total solids weight of the second coating composition.

According to the present disclosure, the second coating or second coating composition may be substantially free, essentially free, or completely free of the aldehyde and/or ketone component described above. A second coating or second composition is substantially free of the aldehyde and/or ketone component if the aldehyde and/or ketone component is present in an amount less than 0.7% by weight, based on the total weight of the second coating or the total solids weight of the second coating composition. A second coating or second composition is essentially free of the aldehyde and/or ketone component if the aldehyde and/or ketone component is present in an amount less than 0.1% by weight, based on the total weight of the second coating or the total solids weight of the second coating composition. A second coating or second composition is completely free of the aldehyde and/or ketone component if the aldehyde and/or ketone component is not present in the second coating or second coating composition, i.e., 0.0% by weight, based on the total weight of the second coating or the total solids weight of the second coating composition.

According to the present disclosure, the second coating or second coating compositions of the present disclosure may optionally further comprise an amino acid. Amino acids will be understood by those skilled in the art as compounds having both acid and amine functionality, with side chains specific to each amino acid. The amino acid may be monomeric or oligomeric, including a dimer. When an oligomeric amino acid is used, the weight average molecular weight, as determined by GPC, of the oligomer is less than 1000 g/mole.

While any of the amino acids can be used according to the present disclosure, particularly suitable are histidine, arginine, lysine, cysteine, cystine, tryphtophan, methionine, phenylalanine and tyrosine. It will be further understood that amino acids can be either L- or D-enantiomers, which are mirror images of each other, and that the L-configurations are typically found in proteins and nature and as such are widely commercially available. The term “amino acids” as used herein therefore refers to both the D- and L-configurations; however, according to the present disclosure, only the L- or only the D-configuration may be included if desired. Amino acids can be purchased, for example, from Sigma Aldrich, Thermo Fisher Scientific, Hawkins Pharmaceutical, or Ajinomato.

The amino acid can be present in any amount that improves the corrosion resistance of the coating. For example, the amino acids may be present in an amount of 0.1 to 20 wt %, such as 2 to 4 wt %, with wt %, based on the total weight of the second coating or total solids weight in the second coating composition.

Alternatively, the second coating or second coating composition may be substantially free, essentially free or completely free of amino acid.

According to the present disclosure, the second coating layer may have a dry film thickness of at least 1 mil, such as at least 1.5 mils, such as at least 2 mils. The second coating layer may have a dry film thickness of no more than 8 mils, such as no more than 4 mils, such as no more than 3 mils, such as no more than 2.5 mils, such as no more than 2 mils. The second coating layer may have a dry film thickness of 1 to 8 mils, such as 1 to 4 mils, such as 1 to 3 mils, such as 1 to 2.5 mils, such as 1 to 2 mils, such as 1.5 to 8 mils, such as 1.5 to 4 mils, such as 1.5 to 3 mils, such as 1.5 to 2.5 mils, such as 1.5 to 2 mils, such as 2 to 8 mils, such as 2 to 4 mils, such as 2 to 3 mils, such as 2 to 2.5 mils.

### Other Optional Components of the First or Second Coating/Coating Composition

According to the present disclosure, the first coating composition or second coating composition may optionally further comprise a liquid medium, and the coating composition may be in the form of a liquid coating composition. As used herein, the term “liquid medium” refers to a liquid material that serves as a carrier for the components of the curable film-forming coating composition that may be substantially or completely removed from the composition upon drying and/or curing. The liquid medium may comprise an organic solvent. The organic solvent may comprise any suitable organic solvent known in the art. When solvent is used as a liquid medium (i.e., diluent), the coating composition may be a solvent borne coating composition. Solvent may be present in an amount such that the liquid medium is a non-aqueous liquid medium. As used herein, the term “non-aqueous medium” refers to a liquid medium comprising less than 50 weight % water, based on the total weight of the liquid medium. Such non-aqueous liquid mediums can comprise less than 40 weight % water, or less than 30 weight % water, or less than 20 weight % water, or less than 10 weight % water, or less than 5% water, or less than 1% water, based on the total weight of the liquid medium. The solvents that make up at least or more than 50 weight % of the liquid medium include organic solvents. Non-limiting examples of suitable organic solvents include polar organic solvents e.g., protic organic solvents such as glycols, glycol ether alcohols, alcohols; and volatile ketones, glycol diethers, esters, and diesters. Other non-limiting examples of organic solvents include aromatic and aliphatic hydrocarbons.

The liquid medium may be present in the first coating composition or second coating composition in an amount of 5-50% by weight, such as 5-40% by weight, such as 10-40% by weight, such as 10-30% by weight, such as 15-25% by weight, based on the total weight of the coating composition.

According to the present disclosure, the first coating composition and/or second coating composition may be substantially free of a liquid medium (i.e., a liquid at room temperature and pressure, such as water and/or organic solvents), such as an organic solvent, wherein the coating composition is in the form of a co-reactable solid in particulate form, i.e., a powder coating composition.

According to the present disclosure, the first coating composition and/or second coating composition may be substantially free of a liquid medium, such as an organic solvent, wherein the coating composition is in the form of a 100% solids composition. As used herein, a “100% solids composition” is a composition in a liquid form that comprises the materials that make up the coating film without a diluent, such as an organic solvent.

According to the present disclosure, the powder coating compositions of the present disclosure may optionally contain additives such as waxes for flow and wetting, flow control agents, such as poly(2-ethylhexyl)acrylate, degassing additives such as benzoin and MicroWax C, adjuvant resin to modify and optimize coating properties, antioxidants, ultraviolet (UV) light absorbers and catalysts. Examples of useful antioxidants and UV light absorbers include those available commercially from Ciba-Geigy under the trademarks IRGANOX and TINUVIN. These optional additives, when used, are typically present in combined amounts of up to 20% by weight, based on total weight of the coating composition. Alternatively, the powder coating composition may independently be substantially, essentially, or completely free of each of these optional components.

The first or second coating or coating compositions of the present disclosure can also include other optional materials. For example, the coating compositions can also comprise a colorant. As used herein, “colorant” refers to any substance that imparts color and/or other opacity and/or other visual effect to the composition. The colorant can be added to the coating in any suitable form, such as discrete particles, dispersions, solutions, and/or flakes. A single colorant or a mixture of two or more colorants can be used in the coatings of the present disclosure. Alternatively, the coating composition may be substantially free, essentially free, or completely free of colorant.

Example colorants include pigments (organic or inorganic), dyes and tints, such as those used in the paint industry and/or listed in the Dry Color Manufacturers Association (DCMA), as well as special effect compositions. A colorant may include, for example, a finely divided solid powder that is insoluble, but wettable, under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, diazo, naphthol AS, benzimidazolone, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, and mixtures thereof. The terms “pigment” and “colored filler” can be used interchangeably.

Example dyes include, but are not limited to, those that are solvent and/or aqueous based such as phthalo green or blue, iron oxide, bismuth vanadate, anthraquinone, and perylene and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions Division of Eastman Chemical, Inc.

Other non-limiting examples of materials that can be used with the coating compositions of the present disclosure include plasticizers, abrasion resistant particles, fillers including, but not limited to, micas, talc, clays, and inorganic minerals, anti-oxidants, hindered amine light stabilizers, UV light absorbers and stabilizers, surfactants, flow and surface control agents, thixotropic agents, organic co-solvents, reactive diluents, catalysts, reaction inhibitors, adhesion promoting agents such as organo-functional alkoxy-silanes, such as epoxy, amine, thiol, or isocyanate functional tri-, di-, or mono-, methoxy, ethoxy, or propoxy silanes, and other customary auxiliaries. Alternatively, the coating composition may be substantially free, essentially free, or completely free of any of the optional ingredients described herein.

According to the present disclosure, the first coating or first coating composition and/or the second coating or second coating composition may be substantially free, essentially free or completely free of magnesium metal particles. As used herein, the term “magnesium metal particles” refers to elemental (zerovalent) magnesium metal and magnesium alloy particles, and does not include compounds thereof, such as for example, the magnesium compounds as defined herein, except as possible particle surface impurities. As used herein, a “magnesium alloy particles” refers to an alloy having magnesium as the predominant metal, such as an alloy comprising at least 51% by weight of magnesium, based on the total weight of the magnesium alloy, and does not include compounds thereof, such as for example, the magnesium compounds as defined herein, except as possible particle surface impurities. As used herein, a coating or coating composition is substantially free of magnesium metal particles if magnesium metal particles are present in an amount of less than 5% by weight, based on the total weight of the coating or the total weight of the solids of the coating composition. As used herein, a coating or coating composition is essentially free of magnesium metal particles if magnesium metal particles present in an amount of less than 1% by weight, based on the total weight of the coating or the total weight of the solids of the coating composition. As used herein, a coating or coating composition is completely free of magnesium metal particles if magnesium metal particles are not present in the coating composition, i.e., 0.00% by weight, based on the total weight of the coating or the total weight of the solids of the coating composition.

According to the present disclosure, the first coating or first coating composition and/or the second coating or second coating composition may be substantially free, essentially free, or completely free of zirconium-containing compounds. A coating or coating composition is substantially free of zirconium-containing compounds if zirconium-containing compounds are present in an amount of less than 0.1% by weight, based on the total weight of the coating or the total weight of the solids of the coating composition. A coating or coating composition is essentially free of zirconium-containing compounds if zirconium-containing compounds are present in an amount of less than 0.002% by weight, based on the total weight of the coating or the total weight of the solids of the coating composition. A coating or coating composition is completely free of zirconium-containing compounds if zirconium-containing compounds are not present in the coating composition, i.e., 0.000% by weight, based on the total weight of the coating or the total weight of the solids of the coating composition.

According to the present disclosure, the first coating or first coating composition and/or the second coating or second coating composition may be substantially free, essentially free, or completely free of microspheres. As used here, the term “microspheres” refers to rounded spheres of glass, ceramic or polymeric material that may be solid or hollow. The microspheres may have a D₅₀ particle diameter of 10 to 120 microns. A coating or coating composition is substantially free of microspheres if microspheres are present in an amount of less than 0.1% by weight, based on the total weight of the coating or the total weight of the solids of the coating composition. A coating or coating composition is essentially free of microspheres if microspheres are present in an amount of less than 0.01% by weight, based on the total weight of the coating or the total weight of the solids of the coating composition. A coating or coating composition is completely free of microspheres if microspheres are not present in the coating composition, i.e., 0.00% by weight, based on the total weight of the coating or the total weight of the solids of the coating composition.

According to the present disclosure, the first coating or first coating composition and/or the second coating or second coating composition may be substantially free, essentially free, or completely free of organic phosphorus compounds. As used herein, the term “organic phosphorus compounds” refers to compounds containing phosphates, phosphites, or phosphonates, and their amine salts or polycondensates. Specific examples include tris(nonylphenyl)phosphate, trixylenyl phosphate, tricresyl phosphate, trioleyl phosphate, tridodecyl phosphate, trioctyl phosphate, tris(2-ethylhexyl) phosphate, tributyl phosphate, triethyl phosphate, tris(butoxyethyl) phosphate, tris(β-chloroethyl) phosphate, tris(2,3-dichloropropyl) phosphate, tris(2,3-dibromopropyl) phosphate, tributyl thiophosphate, tridodecyl thiophosphate, trioleyl thiophosphate, etc.; tris(nonylphenyl) phosphite, trixylenyl phosphite, tricresyl phosphite, triphenyl phosphite, trioleyl phosphite, tri(tridecyl) phosphite, tridodecyl phosphite, tridecyl phosphite, tris(2-ethylhexyl) phosphite, tributyl phosphite, diphenyl decyl phosphite, phenyl didecyl phosphite, tris(nonylphenoxyethoxyethyl) phosphite, tris(butoxy)ethyl phosphite, tris[2-(2-butoxyethoxy)ethyl]phosphite, diphenyl[2-(2-ethoxyethoxy)ethyl]phosphite, tris(dipropylene glycol) phosphite, tridodecyl trithiophosphite, etc.; dibutyl butyl phosphonate, di(2-ethylhexyl) 2-ethylhexyl phosphonate, dioctyl octyl phosphonate, didodecyl dodecyl phosphonate, dioleyl oleyl phosphonate, dibutoxyethyl butoxyethyl phosphonate, etc.; mono or dioleyl phosphate, mono or didodecyl phosphate, mono or di-2-ethylhexyl phosphate, mono or di-n-butyl phosphate, mono or diisobutyl phosphate, mono or di-sec-butyl phosphate, mono or diisopropyl phosphate, mono or diethyl phosphate, etc. and their amine salts; amine salts of acidic phosphoric esters derived from alcohols obtained by addition of dodecanol or oleyl alcohol to ethylene oxide or propylene oxide; mono or bis(nonylphenyl) phosphite, mono or diphenyl phosphite, mono or dioleyl phosphite, mono or didodecyl phosphite, mono or di(2-ethylhexyl) phosphite, mono or di-n-butyl phosphite, mono or diisobutyl phosphite, mono or di-sec-butyl phosphite, mono or diisopropyl phosphite, mono or diethyl phosphite, etc. and their neutralization products with amines; di-2-ethylhexyl hydroxymethyl phosphonate, dibutyl hydroxymethyl phosphonate, etc.; dialkyl dithiophosphates and diaryl dithiophosphates such as diisopropyl dithiophosphate, di-sec-butyl dithiophosphate, diisobutyl dithiophosphate, di-n-butyl dithiophosphate, di-2-ethylhexyl dithiophosphate, dinonylphenyl dithiophosphate, dicresyl dithiophosphate and diphenyl dithiophosphate and their amine salts; pyrophosphoric esters and polyphosphoric esters, and their amine salts; polycondensed organic phosphorus compounds such as dioleyl pentaerythritol diphosphite, tetraoleyl-4,4′-isopropylidenediphenol diphosphite, tetranonylphenyl-4,4′-isopropylidene dicyclohexyl diphosphite, diisodecylpentaerythritol diphosphite, tetraphenyldipropylene glycol diphosphite, bis(neopentylglycol) triethylene glycol diphosphite, tetrakis(nonylphenyl)polypropylene glycol diphosphite, diphenyl diisodecyl neopentyl glycol diphosphite, dineopentyl glycol propylene glycol diphosphite, dineopentyl glycol triethylene glycol diphosphite, dineopentyl glycol dipropylene glycol diphosphite, tetranonylphenyl dipropylene glycol diphosphite, tetrakis[2-(2-ethoxyethoxy)ethyl]dipropylene glycol diphosphite, tetrakis(2-phenoxyethyl)dineopentyl glycol diphosphite, tetrakis(nonylphenoxytetraethylenoxy)neopentyl glycol diphosphite, diphenyl didecyl(2,2,4-trimethyl-1,3-pentanediol) diphosphite, heptakis(dipropylene glycol) triphosphite, octaphenylpentakis(dipropylene glycol) hexaphosphite, decaphenylheptakis(dipropylene glycol) octaphosphite, decakis(nonylphenyl)heptakis(dipropylene glycol) octaphosphite, decakis(nonylphenyl)heptakis(neopentyl glycol) octaphosphite, deca-2-ethylhexylheptakis(dipropylene glycol) octaphosphite, decadodecylheptakis(dipropylene glycol) octaphosphite, diallyl phosphite, vinyl phosphonic ester, etc.; special phosphonates such as tris(dipropylene glycol)bis(hydroxymethane) diphosphonate and bis(dipropylene glycol)-α-hydroxy-β′,β′,β′-trichloroethane phosphonate, and quaternary phosphonium compounds such as methyltrioctyl phosphonium dimethyl phosphate. A coating or coating composition is substantially free of organic phosphorus compounds if organic phosphorus compounds are present in an amount of less than 1% by weight, based on the total weight of the coating or the total weight of the solids of the coating composition. A coating or coating composition is essentially free of organic phosphorus compounds if organic phosphorus compounds are present in an amount of less than 0.7% by weight, based on the total weight of the coating or the total weight of the solids of the coating composition. A coating or coating composition is completely free of organic phosphorus compounds if organic phosphorus compounds are not present in the coating composition, i.e., 0.0% by weight, based on the total weight of the coating or the total weight of the solids of the coating composition.

According to the present disclosure, the first coating or first coating composition and/or the second coating or second coating composition may be substantially free, essentially free or completely free of organic-inorganic hybrid binder materials.

According to the present disclosure, the first coating composition and/or the second coating composition may be in the form of a single component coating composition. A single component coating composition will be understood as referring to a composition wherein all the coating components are maintained in the same container after manufacture, during storage, etc. A typical single component coating composition may be applied to a substrate and cured by any conventional means, such as by heating, forced air, radiation cure and the like. The single component coating composition may also be cured by exposure to ambient conditions. For some coatings, it is not practical to store them as a one-package, but rather they must be stored as multi-component coating compositions with the reactive components (e.g., film-forming polymer and curing agent) stored separately to prevent the components from curing prior to use. The term “multi-component coating composition” means coatings in which various components are maintained separately until just prior to application. The multi-component coating compositions may have any number of separately stored components, such as, for example, two-components, three-components, or four-components coating compositions.

According to the present disclosure, the second coating composition may be in the form of a single component coating composition, wherein the aluminum particles, alkaline earth metal compound, and the organic film-forming binder are present in a single container. Solvent may also optionally be present.

According to the present disclosure, the second coating composition may comprise aluminum particles, an alkaline earth metal compound, and an organic film-forming binder comprising an organic film-forming resin and a curing agent, and the coating composition may be in the form of a multi-component coating composition comprising a first component comprising the organic film-forming resin; and a second component comprising the curing agent; and wherein the aluminum particles and/or alkaline earth metal compound are present in the first component, the second component, an optional third component, or combinations thereof. Additionally, solvent may optionally be present, and if present, a portion or all of the solvent may be present in any of the three components or in an optional fourth component. Furthermore, a portion or all of the other optional ingredients described herein, when present, may be included in any of the components described herein. Although the film-forming resin and curing agent are described as being present in separate components, it should be understood that at least a portion of either component may optionally be present in another component of the coating composition.

The second coating compositions of the present disclosure may be formed by mixing the metal particles, organic film-forming binder, and any of the other optional components. All the components can be mixed in a non-aqueous medium such as the non-aqueous medium previously described. The mixing can include a milling process as recognized by one skilled in the art.

The second coating compositions of the present disclosure may be powder coating compositions and can be prepared, for example, by first dry blending the organic film-forming binder, metal particles, and any of the optional additives described above, in a blender, such as a Henschel blade blender. The blender is operated for a period of time sufficient to result in a homogenous dry blend of the materials. The blend is then melt-blended in an extruder, such as a twin screw co-rotating extruder, operated within a temperature range sufficient to melt but not gel the components. The melt-blended curable powder coating composition may be milled to an average particle size of from, for example, 15 to 80 microns. Other methods known in the art can also be used.

### Third Coating Layer and Third Coating Composition

According to the present disclosure, the coated metal substrate optionally further comprises a third coating layer.

According to the present disclosure, the system for coating a metal substrate optionally further comprises a third coating composition.

The third coating layer is not limited and may include any of those known in the art. For example, the third coating layer may be a topcoat, such as a base coat, a clear coat, a pigmented mono-coat, and color-plus-clear composite compositions. The third coating layer may be waterborne, solventborne, in solid particulate form (i.e., a powder coating composition), or in the form of a powder slurry. The third coating typically includes a film-forming polymer, crosslinking material and, if a colored base coat or mono-coat, one or more pigments. According to the present disclosure, the third coating layer comprises one or more of the topcoat layers which are applied onto a substantially uncured underlying layer. For example, a clear coat layer may be applied onto at least a portion of a substantially uncured basecoat layer (wet-on-wet), and both layers may be simultaneously cured in a downstream process.

The third coating layer may comprise any of the organic film-forming binders or inorganic binders described above. For example, the third coating layer may comprise a polyurethane, a polysiloxane, an acrylic, or the like.

According to the present disclosure, the third coating layer may have a dry film thickness of at least 2 mils, such as at least 3 mils, such as at least 4 mils. The third coating layer may have a dry film thickness of no more than 8 mils, such as no more than 4 mils, such as no more than 3 mils. The third coating layer may have a dry film thickness of 2 to 8 mils, such as 2 to 4 mils, such as 2 to 3 mils, such as 3 to 8 mils, such as 3 to 4 mils, such as 4 to 8 mils.

### Methods of Coating Substrates

The present disclosure is also directed to a method for coating a metal substrate, the method comprising applying a first coating composition onto a surface of the metal substrate to form a first coating layer, the first coating composition comprising zinc particles and a binder comprising a first organic film-forming binder or an inorganic binder, wherein the coating layer comprises zinc particles in an amount of at least 75% by weight, based on the total solids weight of the first coating composition; applying a second coating composition onto the first coating layer to form a second coating layer on the first coating layer, the second coating composition comprising aluminum particles, an alkaline earth metal compound, and a second organic film-forming binder; and optionally applying a third coating composition onto the second coating layer to form a third coating layer.

The method may further comprise subjecting the substrate to curing conditions sufficient to at least partially cure each of the applied coating compositions. The curing conditions may comprise any known in the art, such as, for example, air drying the composition under ambient conditions, heating the coated substrate, subjecting the coated substrate to UV radiation, and/or forced air curing. For example, the first coating composition may be applied to form a first coating layer and permitted to air dry for a period of 2 hours to 1 week prior to application of the second coating layer. Next, the second coating composition may be applied onto the first coating layer to form a second coating layer that may be air dried for 1 hour to 10 days. Finally, the third coating layer optionally may be applied onto the second coating layer.

The method of coating may further comprise other optional steps, such as cleaning and/or degreasing the substrate, grit blasting the substrate surface, anodizing the substrate, pretreating the substrate prior to coating, such as by a metal phosphate pretreatment composition, a zirconium pretreatment composition, a trivalent chromium pretreatment composition, a solgel pretreatment composition, or a rare earth metal pretreatment composition, or other pretreatment compositions.

The metal substrate of the present disclosure comprises metal or metal alloy and may comprise cold rolled steel, hot rolled steel, steel coated with zinc metal, zinc compounds, or zinc alloys, such as electrogalvanized steel, hot-dipped galvanized steel, galvanealed steel, blasted/profiled steel, and steel plated with zinc alloy. As used herein, blasted or profiled steel refers to steel that has been subjected to abrasive blasting and which involves mechanical cleaning by continuously impacting the steel substrate with abrasive particles at high velocities using compressed air or by centrifugal impellers. The abrasives are typically recycled/reused materials and the process can efficiently removal mill scale and rust. The standard grade of cleanliness for abrasive blast cleaning is conducted in accordance with BS EN ISO 8501-1. Aluminum alloys of the 1XXX, 2XXX (such as the 2024 alloy), 3XXX, 4XXX, 5XXX, 6XXX, or 7XXX (such as the 7075 alloy) series as well as clad aluminum alloys and cast aluminum alloys of the A356 series also may be used as the substrate. Magnesium alloys of the AZ31B, AZ91C, AM60B, or EV31A series also may be used as the substrate. The substrate used in the present disclosure may also comprise titanium and/or titanium alloys. Other suitable non-ferrous metals include copper and magnesium, as well as alloys of these materials. Suitable metal substrates for use in the present disclosure include those that are often used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, industrial structures and components such as appliances, including washers, dryers, refrigerators, stoves, dishwashers, and the like, agricultural equipment, lawn and garden equipment, air conditioning units, heat pump units, lawn furniture, and other articles. As used herein, “vehicle” or variations thereof includes, but is not limited to, civilian, commercial and military aircraft, and/or land vehicles such as cars, motorcycles, and/or trucks. The metal substrate also may be in the form of, for example, a sheet of metal or a fabricated part. It will also be understood that the substrate optionally may be pretreated with a pretreatment composition as known in the art. Suitable pretreatment compositions include, but are not limited to, those described above used to pretreat the metal particles. The substrate may also be anodized, including, but not be limited to, phosphoric acid anodized, sulfuric acid anodized, boric-sulfuric acid anodized, tartaric-sulfuric acid anodized. Alternatively, the substrate may be a non-pretreated substrate, such as a bare substrate, that is not pretreated by a pretreatment solution.

The metal substrate may comprise automotive substrates (e.g., automotive vehicles including but not limited to cars, buses, trucks, trailers, etc.), industrial substrates, aerospace vehicle and aerospace vehicle components, marine substrates and components such as ships, vessels, and on-shore and off-shore installations, storage tanks, windmills, nuclear plants, packaging substrates, buildings, bridges, and the like.

According to the present disclosure, the curable film-forming coating composition and/or layers deposited from the same, as well as any pretreatment layer, primer layer or topcoat layer, may be substantially free, essentially free, or completely free of chromium or chromium-containing compounds. As used herein, the term “chromium-containing compound” refers to materials that include trivalent chromium or hexavalent chromium. Non-limiting examples of such materials include chromic acid, chromium trioxide, chromic acid anhydride, dichromate salts, such as ammonium dichromate, sodium dichromate, potassium dichromate, and calcium, barium, magnesium, zinc, cadmium, and strontium dichromate. When the curable film-forming coating composition and/or layers deposited from the same, as well as any pretreatment layer, primer layer or topcoat layer, is substantially free, essentially free, or completely free of chromium, this includes chromium in any form, such as, but not limited to, the trivalent chromium-containing compounds and hexavalent chromium-containing compounds listed above.

Any coating composition and/or coating layers, as well as any pretreatment layer, primer layer or topcoat layer, that is substantially free of chromium or chromium-containing compounds means that chromium or chromium-containing compounds are not intentionally added, but may be present in trace amounts, such as because of impurities or unavoidable contamination from the environment. In other words, the amount of material is so small that it does not affect the properties of the composition; this may further include that chromium or chromium-containing compounds are not present in the coating composition and/or layers deposited from the same, as well as any pretreatment layer, primer layer or topcoat layer, in such a level that they cause a burden on the environment. The term “substantially free” means that the coating composition and/or coating layers deposited from the same, as well as any pretreatment layer, contain less than 10 ppm of chromium, based on total solids weight of the composition, the layer, or the layers, respectively, if any at all. The term “essentially free” means that the coating composition and/or coating layers deposited from the same, as well as any pretreatment layer, contain less than 1 ppm of chromium, based on total solids weight of the composition or the layer, or layers, respectively, if any at all. The term “completely free” means that the coating composition and/or coating layers comprising the same, as well as any pretreatment layer, contain less than 1 ppb of chromium, based on total solids weight of the composition, the layer, or the layers, respectively, if any at all.

According to the present disclosure, any of the coating composition and/or coating layers deposited from the same, may be substantially free, essentially free, or completely free of metal polycarboxylate compounds. As used herein, the term “metal polycarboxylate compound” refers to compounds of metal cations and polycarboxylate polyanions having at least two carboxylic acid groups. Non-limiting examples of metal cations include elements chosen from: Group 1, such as lithium, potassium and sodium, Group 2, such as magnesium, calcium, strontium, and barium, Group 3, such as scandium, yttrium, lanthanum, other lanthanides such as cerium, praseodymium, neodymium, samarium, europium, gadolinium, etc., Group 4, such as titanium and zirconium, Group 5, such as vanadium and niobium, Group 6, such as chromium and molybdenum, Group 7, such as manganese, Group 8, such as iron, cobalt and nickel, Group 11, such as copper, Group 12, such as zinc, Group 13, such as aluminum, and Group 15, such as bismuth. As used herein, the Group number refers to the groups 1 through 18 as defined by the International Union of Pure and Applied Chemistry (IUPAC). Non-limiting examples of polycarboxylate polyanions include linear and branched aliphatic molecules like oxalate, tartrate, succinate, adipate, citrate, and the like, and aromatic molecules like phthalate, diphenate, mellitate and trimellitate, and the like. As used herein, the terms “substantially free” and “essentially free” with respect to the metal polycarboxylate compounds means the metal polycarboxylate compounds are present, if at all, in an amount of 0.1% by weight or less and 0.01% by weight or less, respectively, based on the total binder solids weight of the coating composition or coating.

The present disclosure is also directed to a method of refinishing a surface of an article comprising a metal substrate. The method comprises: (a) removing a defect from the surface; (b) applying a first coating layer deposited from the first coating composition directly to at least a portion of the surface of the metal substrate; (c) applying a second coating layer from a second coating composition over at least a portion of the first coating layer (b); and optionally (d) applying a third coating layer from a third coating composition over at least a portion of the second coating layer (c). It is appreciated that the method can include various steps of applying additional coating layers as well such as a fourth, fifth, or more, coating layers, as well as pretreatment layers applied to the substrate prior to the coatings.

The coating compositions of the present disclosure can be applied by any means standard in the art, such as electrocoating, spraying, electrostatic spraying, dipping, rolling, brushing, flowing, and the like. It is appreciated that the coatings can also be applied in dry forms such as powder or films.

After application of one of the coating compositions to the substrate, a film may be formed on the surface of the substrate by driving solvent out of the film by heating or by an air-drying period. Suitable drying conditions will depend on the particular composition and/or application, but an exemplary drying time of from about 1 to 5 minutes at a temperature of about 60 to 250° F. (15.6 to 121° C.), such as 70 to 212° F. (27 to 100° C.) may be sufficient. Between coats, the previously applied coat may be flashed; that is, exposed to ambient conditions for a desired amount of time.

After application of one of the coating compositions to a substrate, the coating composition may be cured by any means known in the art. For example, the coating may be subjected to curing conditions sufficient to cure the coating composition. For example, the coating composition may be subjected to curing conditions such as ambient conditions, as discussed above, for a period of hours or days. Alternatively, the substrate may be subjected to curing conditions such as radiation (e.g., UV radiation) or heated to a temperature and for a time sufficient to cure the coating.

During curing of the coating, solvents volatilize and crosslinkable components of the composition react and are crosslinked. The curing operation may be carried out at, for example, a temperature in the range of from 60 to 250° F. (15.6 to 121° C.), such as 70 to 212° F. (27 to 100° C.) but, if needed, lower or higher temperatures may be used. The use of elevated temperature may hasten the cure. An example would be forced air curing in a down draft booth at about 40° C. to 60° C., which is common in the automotive refinish industry. However, as noted previously, the coatings of the present disclosure may also cure under ambient conditions without the addition of heat or a forced air-drying step. Additionally, a first coating composition may be applied and then a second applied thereto “wet-on-wet”. Alternatively, the first coating composition can be cured before application of one or more additional coating layers.

According to the present disclosure, after application of a powder film-forming coating composition, the coated substrate can be heated to a temperature and for a time sufficient to cure the coating. Metallic substrates with powder coatings may be cured at a temperature ranging from 250° F. to 500° F. (121.1° C. to 260.0° C.) for 1 to 60 minutes, or from 300° F. to 400° F. (148.9° C. to 204.4° C.) for 15 to 30 minutes, or at temperatures of 392° F. (200° C.) or less for 15 to 30 minutes, such as temperatures of such as 121.1° C. to 200° C., such as 150° C. to 200° C. The curing time may be dependent upon the curing temperature as well as other variables, for example, the film thickness of the deposited coating, type of curing agent employed, and the like. For purposes of the present disclosure, all that is necessary is that the time be sufficient to effect cure of the coating on the substrate.

It was found that the coating system of the present disclosure provides good corrosion resistance when applied to a metallic substrate (e.g., steel) and cured to form a multi-layered coating. For example, the coating system described herein were found to improved scribe appearance when tested under ASTM B117.

According to the present disclosure, the coating system of the present disclosure may reduce scribe corrosion on steel substrates by at least 15%, such as at least 20%, such as at least 30%, such as at least 40%, such as at least 50%, such as at least 60%, when compared to a comparable coating system where the second coating layer does not include aluminum particles and an alkaline earth metal compound, as measured according to ASTM B117 exposure for at least 1,000 hours.

As used herein, unless otherwise defined herein, the term “substantially free” means the ingredient is present in an amount of 1% by weight or less, based on the total solids weight of the coating composition or total weight of the coating, respectively.

As used herein, unless otherwise defined herein, the term “essentially free” means the ingredient is present in an amount of 0.1% by weight or less, based on the total solids weight of the coating composition or total weight of the coating, respectively.

As used herein, unless otherwise defined herein, the term “completely free” means the ingredient is not present in the coating composition, i.e., 0.00% by weight, based on the total solids weight of the coating composition or total weight of the coating, respectively.

As used herein, the term “total solids” refers to the non-volatile content of the film-forming coating composition, i.e., materials which will not volatilize when heated to 110° C. for 15 minutes at standard atmospheric pressure, and specifically includes at least, for example, the metal particles, alkaline earth metal compound, and organic binder of the second coating or second coating composition, or the zinc particles and binder of the first coating or first coating composition.

For purposes of the detailed description, it is to be understood that the disclosure may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Also for molecular weights, whether number average (Mₙ) or weight average (M_{w}), these quantities are determined by gel permeation chromatography using polystyrene as standards as is well known to those skilled in the art and such as is discussed in U.S. Pat. No. 4,739,019, at column 4, lines 2-45.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “a” zinc particle, “an” aluminum particle, “an” alkaline earth metal compound, and “an” organic film-forming binder, a combination (i.e., a plurality) of these components can be used. In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

As used herein, the terms “on,” “onto,” “applied on,” “applied onto,” “formed on,” “deposited on,” “deposited onto,” mean formed, overlaid, deposited, or provided on but not necessarily in contact with the surface. For example, a coating composition “deposited onto” a substrate does not preclude the presence of one or more other intervening coating layers of the same or different composition located between the coating composition and the substrate.

Whereas specific embodiments of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

Illustrating the disclosure are the following examples, which, however, are not to be considered as limiting the disclosure to their details. Unless otherwise indicated, all parts and percentages in the following examples, as well as throughout the specification, are by weight.

### Examples

TABLE 1
Coating Formulations with Untreated Spherical Aluminum
or Untreated Flake Aluminum for Metal Rich Midcoat

| Material | Ex 1 | Ex 2 |
|---|---|---|
| Component A | g | g |
| n- Butyl acetate | 1.13 | 1.13 |
| Epon 863 | 34.09 | 34.09 |
| Epon 1001-A-80 | 38.01 | 38.01 |
| Silbond Condensed | 4.92 | 4.92 |
| Methyl Acetate | 87.85 | 226.11 |
| Suspeno 201-NBA | 3.11 | 3.11 |
| R-706 (TiO₂) | 7.70 | 7.70 |
| Bentone SD-2 | 3.72 | 3.72 |
| Magchem 10-325 | 15.00 | 15.00 |
| nano-MgO | 15.00 | 15.00 |
| Maglite Y | 30.00 | 30.00 |
| Untreated Aluminum | 152.74 | 0 |
| Stapa SDF 6-1501 (Flake | 0 | 77.00 |
| Aluminum) | | |
| Silquest A-187 | 3.26 | 3.26 |
| EFKA PL 5651 | 3.47 | 3.47 |
| BYK-7410 | 1.00 | 1.00 |
| Total | 401.01 | 463.52 |
| Component B | g | g |
| T-Butyl Acetate | 25.00 | 25.00 |
| Butanol | 11.55 | 11.55 |
| Jeffamine D2000 | 3.68 | 3.68 |
| Cardolite NC-556B80 | 34.85 | 34.85 |
| Ancamine 1110 | 1.56 | 1.56 |
| Total | 83.90 | 83.90 |
| Total Blended Weight | 477.64 | 540.16 |

Components in A from n-butyl acetate to Stapa SDF 6-1501 were transferred to a glass jar in sequential order along with milling media at approximately half the weight of the component materials. The jars were sealed with lids and then placed on a Lau Dispersing Unit with a dispersion time of 2 hours. After the pigment dispersion process was completed, Silquest A-187, EFKA PL 5651 and BYK-7410 were added to the Component A mixture and thoroughly mixed. Prior to coating application, components in B were pre-blended until homogenous. The dispersed material in Compound A was combined with Compound B and blended.

Example 1 and Example 2 were used as middle coats (mid-coat) in a three-coat system using a zinc rich coating as the first layer (base coat) and a polyurethane coating as the final layer (topcoat). Example 1 and Example 2 were also used as a final layer (topcoat) in a two-coat system using a zinc rich coating as the first layer (base coat). The examples were compared against commercial epoxy-amine coatings, generally as a middle coat used in this system for protective and marine coatings. Substrate preparation and coating application is outlined below.

The substrate was steel, profiled to 2.0+/−0.5 mils, purchased from ACT Test Panels LLC (item #: 56225). Prior to coating application, the steel substrate was sprayed with pressurized air to remove any loose dirt or dust.

All coating layers were applied with an HVLP spray gun with a 1.9 mm tip and a nozzle pressure of twenty psi. The number of coatings, application speed and distance were varied to achieve the desired dry film build.

The base coat used was Amercoat® 68HS, a three-component zinc-rich epoxy coating composition that includes at least 75% by weight zinc particles, based on the total solids weight of the composition, and an organic binder, and was applied to a dry film thickness of between 2.5-3.0 mils over the profile for Examples A-P and AA-JJ. The base coat was applied to a dry film thickness of between 0.0-0.5 mils over the profile for Examples Q-Z. The panels were then allowed to cure ambiently for twenty-four hours.

The panels were then separated into four distinct sets. These sets would be A-F, G-P, Q-Z and AA-JJ.

Twenty-four hours after basecoat application, the substrate for Examples A-F were separated into six sets of equal size, with each control mid-coat applied over one set of the dried base coat and the metal rich coatings applied over two sets. The mid-coats used as controls were SigmaCover™ 410 and Amerlock® 2/400, at a dry film build of 4.4 and 4.9 mils, respectively. Example 1 and Example 2 were applied to a dry film build of 2.0 and 1.8 mils, respectively. The panels were again allowed to cure ambiently for twenty-four hours.

Twenty-four hours after basecoat application, the substrate for Examples G-JJ were separated into ten sets of equal size, based on their mid-coat and desired dry film build. One panel set was coated in Amerlock® 2/400 at a dry film build of 7.5 mils. Three panel sets were coated in Amerlock® 400 AL at dry film builds of 1.7, 4.2 or 8.6 mils. Three panel sets were coated with Example 1 to a dry film build of 1.5, 4.0 or 7.8 mils. Three panel sets were coated with Example 2 to a dry film build of 1.7, 3.8 or 7.5 mils.

Twenty-four hours after mid-coat application, the six sets for Examples A-F were merged into two sets and coated with either SigmaDur™ 550 or PSX® 700 at a dry film build of 2.8 and 5.5 mils, respectively. Each of the two sets contained a mid-coat control to compare against Example 1 and Example 2. The ten sets for Examples G-Z were merged into one set and coated with Pitthane® Ultra at a dry film thickness of 2.2 mils. The sets for Examples AA-JJ had no further coating systems.

The coated substrate systems were allowed to age under ambient conditions for a minimum of seven days, after which two intersecting lines of 4″ in length were scribed diagonally across the coated surface of each panel, exposing the bare substrate.

A Fowler carbide tipped handheld scribing tool, model number 52-500-050-0, was used to inscribe the coated steel panels.

Scribed test panels of each coating example were then placed into a 5% sodium chloride neutral salt spray cabinet according to ASTM B117 (with the exception that pH and salt concentration was checked weekly as opposed to daily).

Coating sets were separated into thirty-six letters of A-JJ to represent the distinct coating systems applied over each set, which is shown in Table 2, Table 5, Table 7, and Table 9.

Steel panels were rated based on a combination of the scale shown in Table 3 and measurements taken of the scribe.

Some panels were given ratings after exposure without scraping the surface and rated again after scraping the surface. The intention was to understand lifting of the coating system and general blistering of the undisturbed scribe, along with overall scribe corrosion and undercutting of the coating along the freshly scraped scribe.

Panels were scraped with a modified metal tool, using a single sharp edge along the scribe until bare metal was exposed and the limits of the corroded areas were fully uncovered.

Both lifting/blistering of the undisturbed scribe and overall scribe corrosion/undercutting were measured via a ruler, with five points taken and averaged together to gather an overall rating of performance.

The corrosion results for steel panels after exposure are tabulated in Table 4.

TABLE 2
Designation of Coating Sets (A-F) by
their Base, Middle and Top Coatings

| Coating Set | Base Coat | Mid-Coat | Topcoat |
|---|---|---|---|
| A (Comp) | Amercoat ® 68HS | SigmaCover ™ | SigmaDur ™ 550 |
| | | 410 | |
| B | Amercoat ® 68HS | Ex 1 | SigmaDur ™ 550 |
| C | Amercoat ® 68HS | Ex 2 | SigmaDur ™ 550 |
| D (Comp) | Amercoat ® 68HS | Amerlock ® | PSX ® 700 |
| | | 2/400 | |
| E | Amercoat ® 68HS | Ex 1 | PSX ® 700 |
| F | Amercoat ® 68HS | Ex 2 | PSX ® 700 |

TABLE 3
Rating Scale for the Scribe Appearance
of Coated Substrate after B-117

| Rating | Description of Scribe Appearance |
|---|---|
| 10 | Bright and Clean |
| 9 | Bright with slight staining |
| 8 | Lustrous with moderate staining |
| 7 | Loss of luster, no product build-up |
| 6 | Heavy staining, minor corrosion no product build-up |
| 5 | Heavy staining, minor corrosion product build-up |
| 4 | Moderate corrosion product build-up |
| 3 | Major corrosion product build-up |
| 2 | Severe corrosion product build-up |
| 1 | Complete lifting of coating above rust around scribe |
| 0 | Total consumption of coating around scribe |

TABLE 4
Corrosion Performance of Coating Sets
A-F after 7,560 hours in B-117 NSF

| | | Scribe Corrosion (mm) | |
|---|---|---|---|
| | | Lifting / | Total Scribe Corrosion/ |
| | Scribe | Blistering | Undercutting |
| Coating Set | Appearance | (Undisturbed) | (Scraped) |
| A (Comp) | 3 | 1.1 | 2.1 |
| B | 4 | 1.5 | 1.6 |
| C | 5 | 0.7 | 0.9 |
| D (Comp) | 2 | 2.1 | 2.2 |
| E | 8 | 0.5 | 0.5 |
| F | 7 | 0.7 | 1.0 |

The B-117, neutral salt fog corrosion data in TABLE 4 clearly shows that film-forming coating composition Example 1 containing untreated spherical aluminum powder and a magnesium oxide blend in coating sets B and E had measurably better corrosion resistance than the Comparative Commercial Controls (sets A and D). TABLE 4 also clearly shows that curable film-forming coating composition Example 2 containing untreated flake aluminum powder and a magnesium oxide blend in coating sets C and F had measurably better corrosion resistance than the Comparative Commercial Controls (sets A and D).

Evidence of these improvements were the enhanced scribe appearance, reduced scribe lifting and blistering and/or reduced overall scribe corrosion and undercutting.

TABLE 5
Designation of Coating Sets G-P by their Base, Middle and Top
Coatings with variation to dry film thickness (DFT) in mils

| Coating | | | Mid-Coat | |
|---|---|---|---|---|
| Set | Base Coat | Mid-Coat | DFT | Topcoat |
| G (Comp) | Amercoat ® 68HS | Amerlock ® 2/400 | 7.5 | Pitthane ® Ultra |
| H (Comp) | Amercoat ® 68HS | Amerlock ® 400AL | 1.7 | Pitthane ® Ultra |
| I (Comp) | Amercoat ® 68HS | Amerlock ® 400AL | 4.2 | Pitthane ® Ultra |
| J (Comp) | Amercoat ® 68HS | Amerlock ® 400AL | 8.6 | Pitthane ® Ultra |
| K | Amercoat ® 68HS | Ex 1 | 1.5 | Pitthane ® Ultra |
| L | Amercoat ® 68HS | Ex 1 | 4.0 | Pitthane ® Ultra |
| M | Amercoat ® 68HS | Ex 1 | 7.8 | Pitthane ® Ultra |
| N | Amercoat ® 68HS | Ex 2 | 1.7 | Pitthane ® Ultra |
| O | Amercoat ® 68HS | Ex 2 | 3.8 | Pitthane ® Ultra |
| P | Amercoat ® 68HS | Ex 2 | 7.5 | Pitthane ® Ultra |

TABLE 6
Corrosion Performance of Coating Sets
G-P after 2,400 hours in B-117 NSF

| | | Scribe Corrosion (mm) |
|---|---|---|
| | Scribe | Lifting / Blistering |
| Coating Set | Appearance | (Undisturbed) |
| G (Comp) | 5 | 1.5 |
| H (Comp) | 6 | 0.5 |
| I (Comp) | 7 | 0.5 |
| J (Comp) | 8 | 0.5 |
| K | 9 | 0.5 |
| L | 10 | 0.5 |
| M | 10 | 0.0 |
| N | 9 | 0.5 |
| O | 10 | 0.5 |
| P | 10 | 0.5 |

The B-117, neutral salt fog corrosion data in TABLE 6 clearly shows that film-forming coating composition Example 1 containing untreated spherical aluminum powder and a magnesium oxide blend in coating sets K, L and M had measurably better corrosion resistance than the Comparative Commercial Controls (sets G, H, I and J). TABLE 6 also clearly shows that curable film-forming coating composition Example 2 containing untreated flake aluminum powder and a magnesium oxide blend in coating sets N, O and P had measurably better corrosion resistance than the Comparative Commercial Controls (sets G, H, I and J).

Evidence of these improvements were the enhanced scribe appearance and/or reduced scribe lifting and blistering.

TABLE 7
Designation of Coating Sets Q-Z by their Base, Middle and Top
Coatings with variation to dry film thickness (DFT) in mils

| Coating | | | Mid-Coat | |
|---|---|---|---|---|
| Set | Base Coat | Mid-Coat | DFT | Topcoat |
| Q (Comp) | Amercoat ® 68HS | Amerlock ® 2/400 | 7.5 | Pitthane ® Ultra |
| R (Comp) | Amercoat ® 68HS | Amerlock ® 400AL | 1.7 | Pitthane ® Ultra |
| S (Comp) | Amercoat ® 68HS | Amerlock ® 400AL | 4.2 | Pitthane ® Ultra |
| T (Comp) | Amercoat ® 68HS | Amerlock ® 400AL | 8.6 | Pitthane ® Ultra |
| U | Amercoat ® 68HS | Ex 1 | 1.5 | Pitthane ® Ultra |
| V | Amercoat ® 68HS | Ex 1 | 4.0 | Pitthane ® Ultra |
| W | Amercoat ® 68HS | Ex 1 | 7.8 | Pitthane ® Ultra |
| X | Amercoat ® 68HS | Ex 2 | 1.7 | Pitthane ® Ultra |
| Y | Amercoat ® 68HS | Ex 2 | 3.8 | Pitthane ® Ultra |
| Z | Amercoat ® 68HS | Ex 2 | 7.5 | Pitthane ® Ultra |

TABLE 8
Corrosion Performance of Coating Sets
Q-Z after 2,400 hours in B-117 NSF

| | | Scribe Corrosion (mm) |
|---|---|---|
| | Scribe | Lifting / Blistering |
| Coating Set | Appearance | (Undisturbed) |
| Q (Comp) | 5 | 3.2 |
| R (Comp) | 6 | 3.2 |
| S (Comp) | 6 | 3.2 |
| T (Comp) | 6 | 3.4 |
| U | 8 | 0.5 |
| V | 9 | 0.5 |
| W | 8 | 0.0 |
| X | 6 | 1.0 |
| Y | 7 | 1.0 |
| Z | 7 | 1.0 |

The B-117, neutral salt fog corrosion data in TABLE 8 clearly shows that film-forming coating composition Example 1 containing untreated spherical aluminum powder and a magnesium oxide blend in coating sets U, V and W had measurably better corrosion resistance than the Comparative Commercial Controls (sets Q, R, S and T). TABLE 8 also clearly shows that curable film-forming coating composition Example 2 containing untreated flake aluminum powder and a magnesium oxide blend in coating sets X, Y and Z had measurably better corrosion resistance than the Comparative Commercial Controls (sets Q, R, S and T).

Evidence of these improvements was the enhanced scribe appearance and/or reduced scribe lifting and blistering.

TABLE 9
Designation of Coating Sets (AA-JJ) by their Base and Top
Coatings with variation to dry film thickness (DFT) in mils

| | | | Topcoat |
|---|---|---|---|
| Coating Set | Base Coat | Topcoat | DFT |
| AA (Comp) | Amercoat ® 68HS | Amerlock ® 2/400 | 7.5 |
| BB (Comp) | Amercoat ® 68HS | Amerlock ® 400AL | 1.7 |
| CC (Comp) | Amercoat ® 68HS | Amerlock ® 400AL | 4.2 |
| DD (Comp) | Amercoat ® 68HS | Amerlock ® 400AL | 8.6 |
| EE | Amercoat ® 68HS | Ex 1 | 1.5 |
| FF | Amercoat ® 68HS | Ex 1 | 4.0 |
| GG | Amercoat ® 68HS | Ex 1 | 7.8 |
| HH | Amercoat ® 68HS | Ex 2 | 1.7 |
| II | Amercoat ® 68HS | Ex 2 | 3.8 |
| JJ | Amercoat ® 68HS | Ex 2 | 7.5 |

TABLE 10
Corrosion Performance of Coating Sets
AA-JJ after 2,400 hours in B-117 NSF

| | | Scribe Corrosion (mm) |
|---|---|---|
| | Scribe | Lifting / Blistering |
| Coating Set | Appearance | (Undisturbed) |
| AA (Comp) | 8 | 0.5 |
| BB (Comp) | 8 | 0.5 |
| CC (Comp) | 7 | 0.5 |
| DD (Comp) | 8 | 0.5 |
| EE | 9 | 0.5 |
| FF | 10 | 0.5 |
| GG | 10 | 0.0 |
| HH | 10 | 0.5 |
| II | 10 | 0.0 |
| JJ | 10 | 0.0 |

The B-117, neutral salt fog corrosion data in TABLE 10 clearly shows that film-forming coating composition Example 1 containing untreated spherical aluminum powder and a magnesium oxide blend in coating sets EE, FF, and GG had measurably better corrosion resistance than the Comparative Commercial Controls (sets AA, BB, CC and DD). TABLE 10 also clearly shows that curable film-forming coating composition Example 2 containing untreated flake aluminum powder and a magnesium oxide blend in coating sets HH, II and JJ had measurably better corrosion resistance than the Comparative Commercial Controls (sets AA, BB, CC and DD).

Evidence of these improvements was the enhanced scribe appearance and/or reduced scribe lifting and blistering.

Table 11 provides a description of materials used in the preparation of the examples.

TABLE 11
Components and Raw Materials

| Component | Description | Supplier |
|---|---|---|
| Ancamine ® 1110 | Dimethylaminomethylphenol | Evonik |
| | (catalyst) | |
| Bentone ® SD-2 | Bentonite Clay | Elementis Specialties |
| BYK ®-7410 | High molecular weight | BYK |
| | wetting agent | |
| Cardolite ® NC-556B80 | Phenalkamine | Cardolite |
| Ti-Pure ® R-706-11 | Titanium Dioxide | DuPont |
| EFKA ® PL 5651 | Epoxy Plasticizer | BASF |
| Epon ™ 863 | Bisphenol F / epichlorohydrin | Hexion |
| | resin | |
| Epon ™ 1001-A-80 | Bisphenol A / | Hexion |
| | epichlorohydrin resin | |
| Silquest ® A187 | Epoxy-silane | Momentive |
| Jeffamine ® D2000 | Polyetheramines/diamine | Huntsman |
| Nano Magnesium Oxide | MgO: 20 nm ave. particle | Nano Structured and |
| | size, 50 m²/g surface area | Amorphous Materials |
| Maglite ® Y | MgO: 10 micron ave. particle | Hallstar |
| | size, 55 m²/g surface area | |
| Magchem ® 10-325 | MgO: 10 micron ave. particle | Martin Marietta Magnesia |
| | size, 3 m²/g surface area | Specialties |
| Untreated Aluminum Powder | MIL-DTL-24779A (95% | Valimet, Inc |
| | aluminum, 5% zinc, 0.015% | |
| | indium) aluminum alloy | |
| | atomized to D50 7 μm | |
| | spherical powder | |
| Flake Aluminum | Silver dollar, non-leafing | Eckart |
| (Stapa SDF 6-1501) | aluminum pigment | |
| Silbond Condensed | Ethyl Silicate | Silbond |
| Suspeno 201-NBA | Rheology additive | Poly-Resin Inc |
| Milling media | Part #74582 minimum 85% | Coors Tek |
| | A1203 (16 to 20 mesh) | |
| Profiled Cold Rolled Steel | Profiled by ACT to 2.0 +/− | ACT Test Panels LLC |
| Substrate | 0.5 mils | |
| Amercoat ® 68HS Base | Product Code: AT68HS-A/01 | PPG |
| Amercoat ® 68HS Cure | Product Code: AT68HS-B/01 | PPG |
| Zinc Powder | Product Code: AT68HS-P/01 | PPG |
| SigmaCover ™ 410 Base | Product Code: 6C1050438 | PPG |
| SigmaCover ™ 410 Cure | Product Code: 00231302 | PPG |
| Amerlock ® 2/400 Base | Product Code: AK2-3 | PPG |
| Amerlock ® 2/400 Cure | Product Code: AK2-B/01 | PPG |
| SigmaDur ™ 550 Base | Product Code: 00393122 | PPG |
| SigmaDur ™ 550 Cure | Product Code: 00238758 | PPG |
| PSX ® 700 Base | Product Code: 00336052 | PPG |
| PSX ® 700 Cure | Product Code: 00336129 | PPG |

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. A coated metal substrate comprising:
a first coating layer comprising zinc particles and a binder comprising a first organic film-forming binder or an inorganic binder, wherein the first coating layer comprises zinc particles in an amount of at least 75% by weight, based on the total weight of the first coating layer;
a second coating layer on the first coating layer, the second coating layer comprising aluminum particles, an alkaline earth metal compound, and a second organic film-forming binder; and
optionally, a third coating layer.

2. The coated metal substrate of claim 1, wherein the second coating layer comprises aluminum particles in an amount of 5% to 50% by weight, based on the total weight of the second coating layer.

3. The coated metal substrate of claim 1, wherein the second coating layer comprises the alkaline earth metal compound in an amount of 6% to 20% by weight, based on the total weight of the second coating layer.

4. The coated metal substrate of claim 1, wherein the alkaline earth metal compound comprises a compound of beryllium, magnesium, calcium, strontium, barium, or any combination thereof.

5. The coated metal substrate of claim 1, wherein the alkaline earth metal compound comprises magnesium oxide, magnesium carbonate, magnesium hydroxide, magnesium sulfate, magnesium monocarboxylate, magnesium phosphate, calcium oxide, calcium carbonate, calcium hydroxide, calcium sulfate, calcium monocarboxylate, calcium phosphate, strontium oxide, strontium carbonate, strontium hydroxide, strontium sulfate, strontium monocarboxylate, strontium phosphate, barium oxide, barium carbonate, barium hydroxide, barium sulfate, barium monocarboxylate, barium phosphate, beryllium oxide, beryllium carbonate, beryllium hydroxide, beryllium sulfate, beryllium monocarboxylate, beryllium phosphate, or combinations thereof.

6. The coated metal substrate of claim 1, wherein the alkaline earth metal compound comprises magnesium oxide.

7. The coated metal substrate of claim 1, wherein the binder comprises the first organic film-forming binder comprising a film-forming resin.

8. The coated metal substrate of claim 7, wherein the film-forming resin comprises an epoxy resin.

9. The coated metal substrate of claim 1, wherein the second organic film forming binder comprises a film-forming resin.

10. The coated metal substrate of claim 9, wherein the film-forming resin comprises an epoxy resin.

11. The coated metal substrate of claim 1, wherein the third coating layer is present and comprises a topcoat.

12. The coated metal substrate of claim 11, wherein the topcoat comprises a polyurethane coating, a polysiloxane coating, an epoxy coating, or an acrylic coating.

13. The coated metal substrate of claim 1, wherein the first coating layer has a dry film thickness of 2 to 8 mils.

14. The coated metal substrate of claim 1, wherein the second coating layer has a dry film thickness of 1 to 8 mils.

15. The coated metal substrate of claim 1, wherein the third coating layer is present and has a dry film thickness of 2 to 8 mils.

16. A system for coating a metal substrate, the system comprising:
a first coating composition comprising zinc particles and a binder comprising a first organic film-forming binder or an inorganic binder, wherein the first coating composition comprises zinc particles in an amount of at least 75% by weight, based on the total solids weight of the first coating composition;
a second coating composition comprising aluminum particles, an alkaline earth metal compound, and a second organic film-forming binder; and
optionally, a third coating composition.

17. A method for coating a metal substrate, the method comprising:
applying a first coating composition onto a surface of the metal substrate to form a first coating layer, the first coating composition comprising zinc particles and a binder comprising a first organic film-forming binder or an inorganic binder, wherein the coating layer comprises zinc particles in an amount of at least 75% by weight, based on the total solids weight of the first coating composition;
applying a second coating composition onto the first coating layer to form a second coating layer on the first coating layer, the second coating composition comprising aluminum particles, an alkaline earth metal compound, and a second organic film-forming binder; and
optionally, applying a third coating composition onto the second coating layer to form a third coating layer.

18. The method of claim 17, wherein the second coating composition is applied onto the first coating layer from 2 hours to 7 days after the first coating composition was applied to the metal substrate.

19. The method of claim 17, wherein the third coating composition is applied onto the second coating layer from 1 hour to 10 days after the second coating composition was applied to the metal substrate.
